(19) United States
(12) Patent Application Publication
(10) Pub. No.: US 2022/0141693 A1
(43) Pub. Date: May 5, 2022

(54) QUALITY REPORTING METHOD FOR CORESET IN WIRELESS COMMUNICATION SYSTEM, AND TERMINAL USING METHOD

(71) Applicant: LG ELECTRONICS INC., Seoul (KR)

(72) Inventors: Inkwon Seo, Seoul (KR); Joonkui Ahn, Seoul (KR); Changhwan Park, Seoul (KR)

(21) Appl. No.: 17/428,559

(22) PCT Filed: Mar. 30, 2020
(86) PCT No.: PCT/KR2020/004377

§ 371 Date: Aug. 4, 2021

Related U.S. Application Data
(60) Provisional application No. 62/828,417, filed on Apr. 2, 2019.

(30) Foreign Application Priority Data
May 2, 2019 (KR) 10-2019-0051782

(51) Int. Cl. H04W 24/10; H04W 72/04

(52) U.S. Cl. CPC H04W 24/10; H04W 72/0413

(57) ABSTRACT

Provided in the present specification is a method by which a terminal transmits a control resource set (CORESET) measurement report in a wireless communication system, the method: receiving CORESET configuration information from a base station, wherein the CORESET configuration information includes information about one or more CORESETs; measuring each of one or more CORESETs; and transmitting the CORESET measurement report to the base station on the basis of the measurement result.

### BACKGROUND OF THE DISCLOSURE

### Field of the Disclosure

The present specification relates to wireless communication.

### Related Art

As a wider range of communication devices require larger communication capacities, the need for mobile broadband communication that is more enhanced than the existing Radio Access Technology (RAT) is rising. Additionally, massive Machine Type Communications (massive MCT), which connects multiple devices and objects so as to provide various services regardless of time and place, is also one of the most important issues that are to be considered in the next generation communication. Moreover, discussions are made on services/terminals (or user equipment (UE)) that are sensitive to reliability and latency. And, discussions are made on the adoption of a next generation radio access technology that is based on the enhanced mobile broadband communication, massive MTC, Ultra-Reliable and Low Latency Communication (URLLC), and so on. And, for convenience, the corresponding technology will be referred to as a new radio access technology (new RAT or NR).

Hereinafter, in the present specification, a method for transmitting a report of measurement and an apparatus using the same are proposed.

### SUMMARY OF THE DISCLOSURE

### Technical Solutions

According to an embodiment of the present specification, there is provided a method to comprise performing measurement on each of at least one CORESET and transmitting a CORESET measurement report to a base station based on the measurement result.

### EFFECTS OF THE DISCLOSURE

According to the present specification, a configuration for performing measurement for each CORESET and reporting on a low quality CORESET is defined. In other words, when the reception performance of the corresponding CORESET is degraded in units of CORESET, a procedure for changing the transmission configuration indication (TCI) information of CORESET or CORESET or a related measurement report procedure is defined, and then, the network may know the reception performance for each CORESET of a specific UE. For this reason, when a beam configured in the existing CORESET of the UE cannot be received, unnecessary monitoring of the PDCCH may not be performed. In addition, in terms of the network, a problem in which unnecessary resource waste occurs can be solved.

The effects that can be obtained through a specific example of the present specification are not limited to the effects listed above. For example, there may be various technical effects that a person having ordinary skill in the related art can understand or derive from the present specification. Accordingly, specific effects of the present specification are not limited to those explicitly described in the present specification, and may include various effects that can be understood or derived from the technical features of the present specification.

### BRIEF DESCRIPTION OF THE DRAWINGS

FIG. 1 illustrates a wireless communication system.

FIG. 2 is a diagram showing a wireless protocol architecture for a user plane.

FIG. 3 is a diagram showing a wireless protocol architecture for a control plane.

FIG. 4 illustrates a system structure of a new generation radio access network (NG-RAN) to which NR is applied.

FIG. 5 illustrates functional partitioning between NG-RAN and SGC.

FIG. 6 illustrates a frame structure applicable in NR.

FIG. 7 illustrates a CORESET.

FIG. 8 is a view illustrating a difference between a legacy control region and a CORESET in the NR.

FIG. 9 illustrates an example of a frame structure for the new radio access technology (new RAT).

FIG. 10 is an abstract diagram of a hybrid beamforming structure in the viewpoints of the TXRU and physical antenna.

FIG. 11 is a schematic diagram of the beam sweeping operation for a synchronization signal and system information during a downlink (DL) transmission process.

FIG. 12 shows examples of 5G usage scenarios to which the technical features of the present specification can be applied.

FIG. 13 illustrates a scenario in which three different bandwidth parts are configured.

FIG. 14 is a flowchart of a method for transmitting a report on a measurement result according to an embodiment of the present specification.

FIG. 15 is a flowchart of a quality report for CORESET deactivation according to an embodiment of the present specification.

FIG. 16 is a flowchart of a method for configuring a reference resource and a control channel CSI measurement according to an embodiment of the present specification.

FIG. 17 is a flowchart of a method of transmitting a report on a measurement result from the viewpoint of a UE, according to an embodiment of the present specification.

FIG. 18 is an example of a block diagram of an apparatus for transmitting a report on a measurement result from the viewpoint of a UE, according to an embodiment of the present specification.

FIG. 19 is a flowchart of a method of receiving a report on a measurement result from the viewpoint of a base station, according to an embodiment of the present specification.

FIG. 20 is an example of a block diagram of an apparatus for receiving a report on a measurement result from the viewpoint of a base station, according to an embodiment of the present specification.

FIG. 21 shows an exemplary communication system (1), according to an embodiment of the present specification.

FIG. 22 shows an exemplary wireless device to which the present specification can be applied.

FIG. 23 shows another example of a wireless device applicable to the present specification.

FIG. 24 shows a signal process circuit for a transmission signal according to an embodiment of the present specification.

FIG. 25 shows another example of a wireless device according to an embodiment of the present specification.

FIG. 26 shows a hand-held device to which the present specification is applied.

FIG. 27 shows a vehicle or an autonomous vehicle to which the present specification is applied.

### DESCRIPTION OF EXEMPLARY EMBODIMENTS

In the present specification, “A or B” may mean “only A”, “only B” or “both A and B”. In other words, in the present specification, “A or B” may be interpreted as “A and/or B”. For example, in this specification, “A, B or C” refers to “only A”, “only B”, “only C”, or “any combination of A, B and C”.

A forward slash (/) or comma used herein may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” can be interpreted the same as “at least one of A and B”.

In addition, in the present specification, “at least one of A, B and C” means “only A”, “only B”, “only C”, or “any combination of A, B and C”. In addition, “at least one of A, B or C” or “at least one of A, B and/or C” can mean “at least one of A, B and C”.

In addition, parentheses used in the present specification may mean “for example”. Specifically, when described as “control information (PDCCH)”, “PDCCH” may be proposed as an example of “control information”. In other words, “control information” of the present specification is not limited to “PDCCH”, and “PDDCH” may be suggested as an example of “control information”. In addition, even when described as “control information (i.e., PDCCH)”, “PDCCH” may be proposed as an example of “control information”.

In the present specification, technical features that are individually described in one drawing may be implemented individually or at the same time.

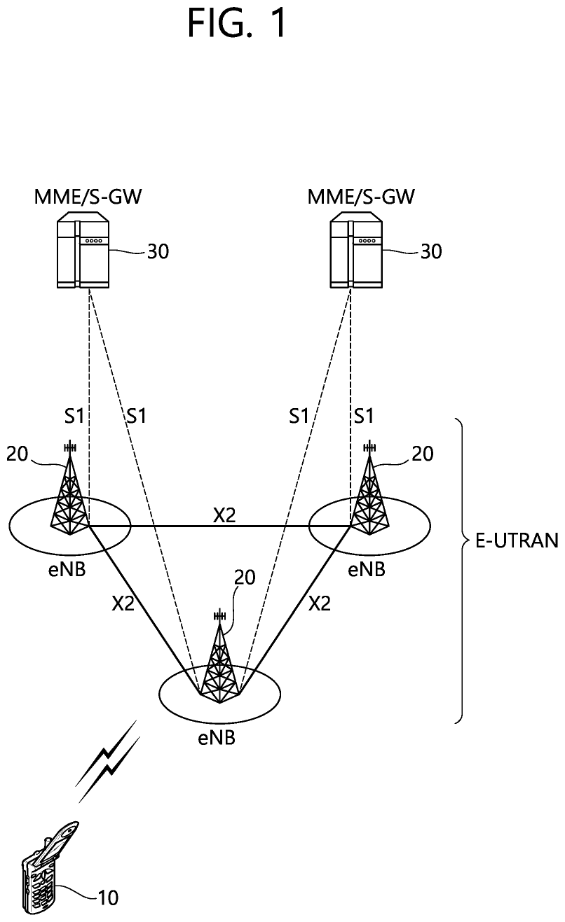

FIG. 1 illustrates a wireless communication system. The wireless communication system may also be referred to as an evolved-UMTS terrestrial radio access network (E-UTRAN), or long term evolution (LTE)/LTE-A system.

The E-UTRAN includes at least one base station (BS) (20) which provides a control plane and a user plane to a user equipment (UE) (10). The UE (10) may be fixed or mobile, and may be referred to as another terminology, such as a mobile station (MS), a user terminal (UT), a subscriber station (SS), a mobile terminal (MT), a wireless device, and so on. The BS (20) is generally a fixed station that communicates with the UE (10) and may be referred to as another terminology, such as an evolved node-B (eNB), a base transceiver system (BTS), an access point, and so on.

The BSs (20) are interconnected by means of an X2 interface. The BSs (20) are also connected by means of an S1 interface to an evolved packet core (EPC) (30), more specifically, to a mobility management entity (MME) through S1-MME and to a serving gateway (S-GW) through S1-U.

The EPC (30) includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

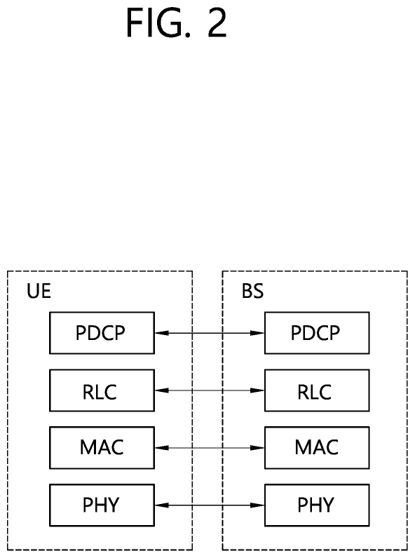

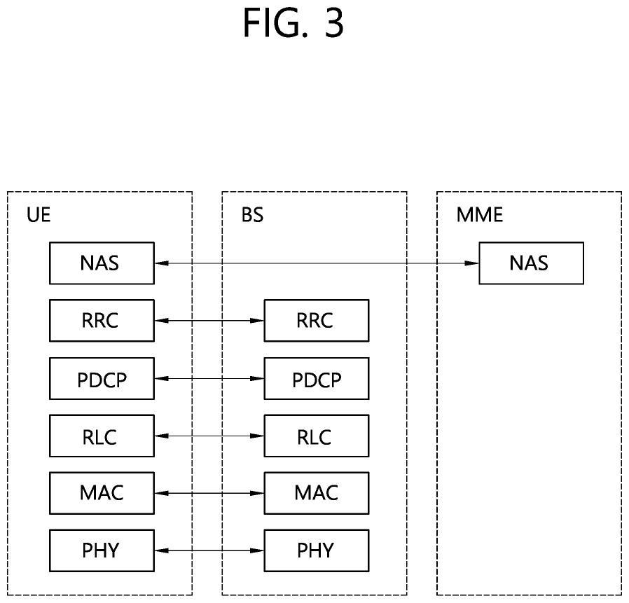

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel The PHY layer is connected to a medium access control (MAC) layer which is an upper layer of the PHY layer through a transport channel Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel The MAC layer provides service to a Radio Link Control (RLC) layer through the logical channel

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a procedure of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel A Transmission Time Interval (TTI) is a unit time for subframe transmission.

Hereinafter, a new radio access technology (new RAT, NR) will be described.

As a wider range of communication devices require larger communication capacities, the need for mobile broadband communication that is more enhanced than the existing Radio Access Technology (RAT) is rising. Additionally, massive Machine Type Communications (massive MCT), which connects multiple devices and objects so as to provide various services regardless of time and place, is also one of the most important issues that are to be considered in the next generation communication. Moreover, discussions are made on services/terminals (or user equipment (UE)) that are sensitive to reliability and latency. And, discussions are made on the adoption of a next generation radio access technology that is based on the enhanced mobile broadband communication, massive MTC, Ultra-Reliable and Low Latency Communication (URLLC), and so on. And, for convenience, the corresponding technology will be referred to as a new RAT or NR.

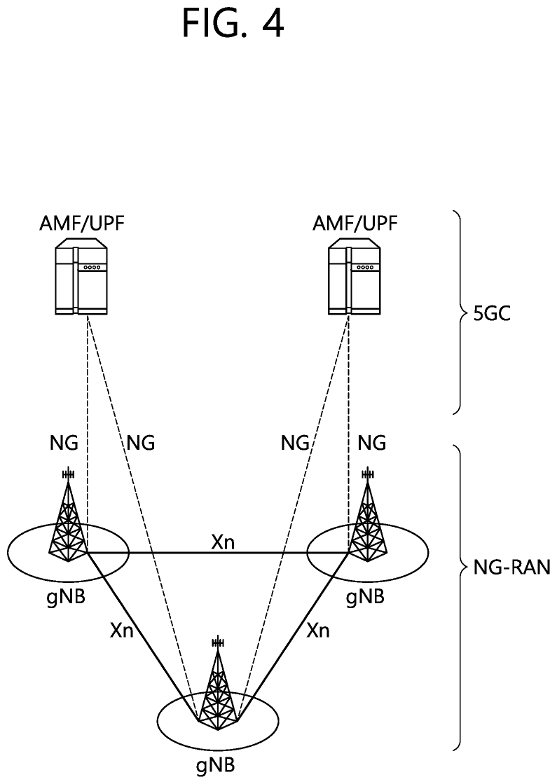

FIG. 4 illustrates a system structure of a new generation radio access network (NG-RAN) to which NR is applied.

Referring to FIG. 4, the NG-RAN may include a gNB and/or an eNB providing a user plane and a control plane protocol termination to a terminal. FIG. 4 illustrates a case of including only the gNB. The gNB and eNB are connected to each other by an Xn interface. The gNB and eNB are connected to a 5G Core Network (5GC) through an NG interface. More specifically, the gNB and eNB are connected to the access and mobility management function (AMF) through an NG-C interface and connected to a user plane function (UPF) through an NG-U interface.

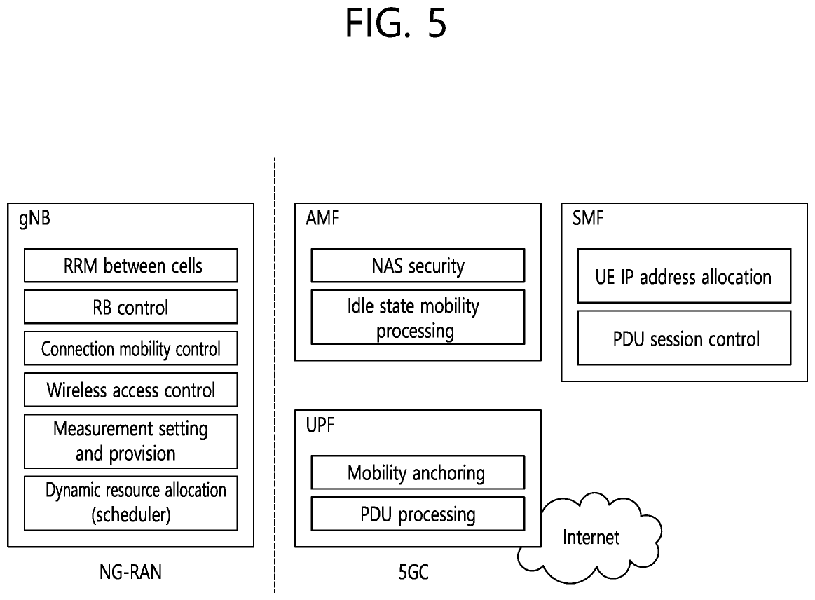

FIG. 5 illustrates functional partitioning between NG-RAN and 5GC.

Referring to FIG. 5, the gNB may provide inter-cell radio resource management (RRM), radio bearer (RB) control, connection mobility control, radio access control, measurement configuration & provision, dynamic resource allocation, and the like. An AMF may provide functions such as NAS security, idle state mobility handling, and the like. A UPF may provide functions such as mobility anchoring, PDU handling, and the like. A session management function (SMF) may provide functions such as UE IP address allocation, PDU session control, and the like.

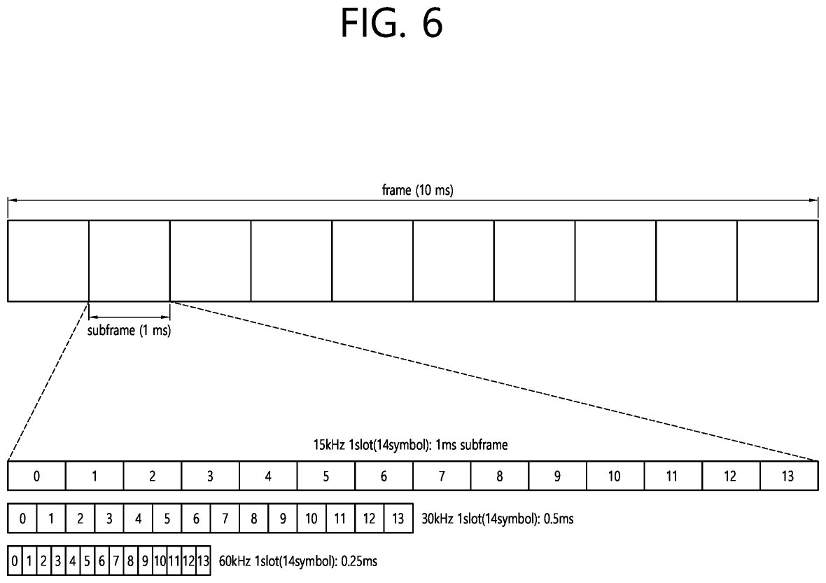

FIG. 6 illustrates a frame structure applicable in NR.

Referring to FIG. 6, a frame may consist of 10 milliseconds (ms) and may include 10 subframes of 1 ms.

A subframe may include one or a plurality of slots according to subcarrier spacing.

Table 1 below shows subcarrier spacing configuration μ.

TABLE 1

| μ | Δf = 2^{μ} · 15 [kHz] | CP(Cyclic Prefix) |
|---|---|---|
| 0 | 15 | Normal |
| 1 | 30 | Normal |
| 2 | 60 | Normal, Extended |
| 3 | 120 | Normal |
| 4 | 240 | Normal |

Table 2 below shows the number of slots in a frame (N^{frameμ}ₛₗₒₜ), the number of slots in a subframe (N^{subframeμ}ₛₗₒₜ), and the number of symbols in a slot (N^{slot}_{symb}) according to the subcarrier spacing configuration μ.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

FIG. 6 shows μ=0, 1, and 2.

A physical downlink control channel (PDCCH) may include one or more control channel elements (CCEs) as shown in Table 3 below.

TABLE 3

| Aggregation level | Number of CCEs |
|---|---|
| 1 | 1 |
| 2 | 2 |
| 4 | 4 |
| 8 | 8 |
| 16 | 16 |

In other words, the PDCCH may be transmitted through a resource including 1, 2, 4, 8 or 16 CCEs. Here, the CCE includes six resource element groups (REGs), and one REG includes one resource block in the frequency domain and one orthogonal frequency division multiplexing (OFDM) symbol in the time domain. Meanwhile, in the NR, a new unit called a control resource set (CORESET) may be introduced. A UE may receive the PDCCH in the CORESET.

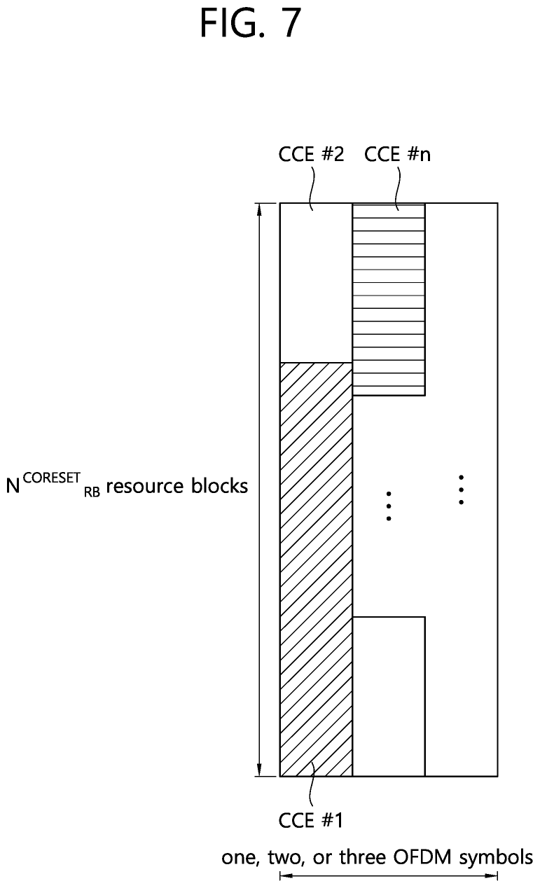

FIG. 7 illustrates a CORESET.

Referring to FIG. 7, the CORESET may include N^{CORESET}_{RB} resource blocks in the frequency domain and N^{CORESET}_{symb} ∈ {1, 2, 3} symbols in the time domain. N^{CORESET}_{RB} and N^{CORESET}_{symb} may be provided by a base station (BS) through higher layer signaling. As shown in FIG. 7, a plurality of CCEs (or REGs) may be included in the CORESET.

The UE may attempt to detect a PDCCH in units of 1, 2, 4, 8 or 16 CCEs in the CORESET. One or a plurality of CCEs for attempting PDCCH detection may be referred to as PDCCH candidates.

A plurality of CORESETs may be configured for the UE.

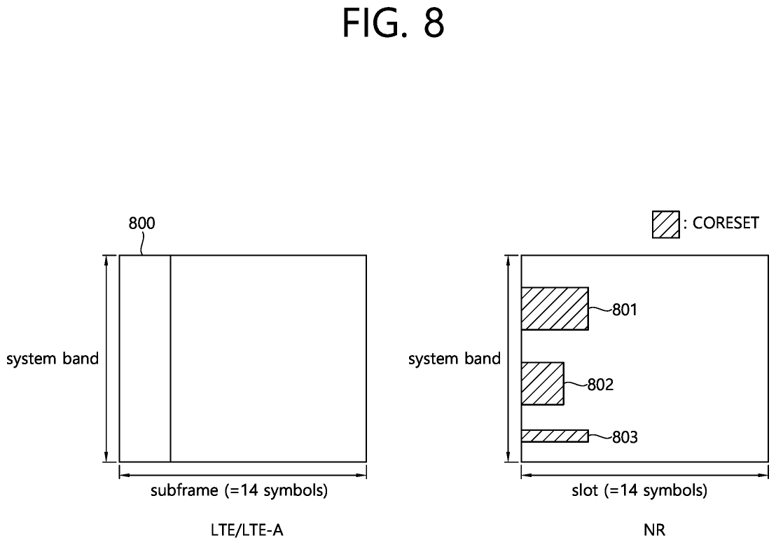

FIG. 8 is a view illustrating a difference between a legacy control region and a CORESET in the NR.

Referring to FIG. 8, a control region 800 in the legacy wireless communication system (e.g., LTE/LTE-A) is configured in the entire system band used by a BS. All terminals, excluding some UEs that support only a narrow band (e.g., eMTC/NB-IoT terminals), were supposed to be able to receive wireless signals of the entire system band of the BS in order to properly receive/decode control information transmitted from the BS.

Meanwhile, in the NR, the aforementioned CORESET was introduced. CORESETs (801, 802, 803) may be radio resources for control information that the UE should receive and may use only a part of the system band, not the entire system band. The BS may allocate the CORESET to each terminal, and may transmit control information through the allocated CORESET. For example, in FIG. 8, a first CORESET (801) may be allocated to UE 1, a second CORESET (802) may be allocated to UE 2, and a third CORESET (803) may be allocated to UE 3. The UE in the NR may receive the control information from the BS even if the UE does not necessarily receive the entire system band.

The CORESET may include a UE-specific CORESET for transmitting UE-specific control information and a common CORESET for transmitting control information common to all UEs.

Meanwhile, in the NR, high reliability may be required depending on an application field, and in this context, a target block error rate (BLER) for a downlink control information (DCI) transmitted through a downlink control channel (e.g., physical downlink control channel (PDCCH)) may be significantly lower than that of the related art. As an example of a method for satisfying the requirement for such high reliability, the amount of contents included in the DCI may be reduced and/or the amount of resources used in DCI transmission may be increased. Here, the resource may include at least one of a resource in the time domain, a resource in the frequency domain, a resource in a code domain, and a resource in a spatial domain.

The following technologies/characteristics may be applied to NR.

<Self-contained subframe structure>

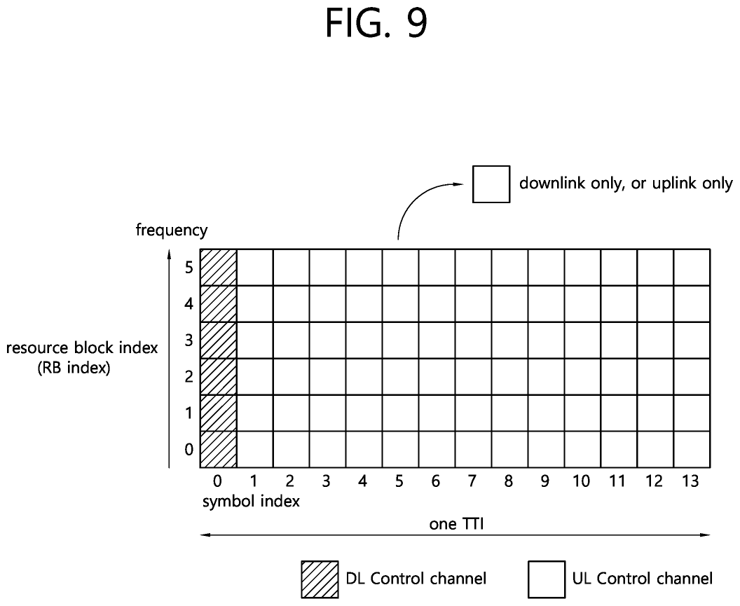

FIG. 9 illustrates an example of a frame structure for the new radio access technology (new RAT).

In NR, as a purpose for minimizing latency, as shown in FIG. 9, a structure having a control channel and a data channel being processed with Time Division Multiplexing (TDM), within one TTI, may be considered as one type of frame structure.

In FIG. 9, an area marked with slanted lines represents a downlink control area, and an area marked in black represents an uplink control area. An area marked in black may be used for downlink (DL) data transmission or may be used for uplink (UL) data transmission. The characteristic of such structure is that, since downlink (DL) transmission and uplink (UL) transmission are carried out sequentially, DL data is sent out (or transmitted) from a subframe, and UL Acknowledgement/Not-acknowledgement (ACK/NACK) may also be received in the subframe. As a result, time needed until data retransmission, when a data transmission error occurs, may be reduced, and, accordingly, latency in the final data transfer (or delivery) may be minimized

In the above-described data and control TDMed subframe structure, a time gap is needed for a transition process (or shifting process) from a transmission mode to a reception mode of the base station and UE, or a transition process (or shifting process) from a reception mode to a transmission mode of the base station and UE. For this, in a self-contained subframe structure, some of the OFDM symbols of a time point where a transition from DL to UL occurs may be configured as a guard period (GP).

<Analog Beamforming #1>

In a Millimeter Wave (mmW), since the wavelength becomes short, installation of multiple antenna elements on a same surface becomes possible. That is, on a 30 GHz band, the wavelength is 1 cm, thereby enabling installation of a total of 100 antenna elements to be performed on a 5 by 5 cm panel in a 2-dimension (2D) alignment format at intervals of 0.5 wavelength (lambda). Therefore, in mmW, coverage shall be extended or throughput shall be increased by increasing beamforming (BF) gain using multiple antenna elements.

In this case, when a Transceiver Unit (TXRU) is provided so as to enable transport power and phase adjustment to be performed per antenna element, independent beamforming per frequency resource may be performed. However, there lies a problem of reducing effectiveness in light of cost in case of installing TXRU to all of the 100 or more antenna elements. Therefore, a method of mapping multiple antenna elements to one TXRU and adjusting beam direction by using an analog phase shifter is being considered. Since such analog beamforming method can only form a single beam direction within a full band, it is disadvantageous in that in cannot provide frequency selective beamforming.

As an intermediate form of digital beamforming (digital BF) and analog beamforming (analog BF), hybrid beamforming (hybrid BF) having B number of TXRUs, which is less than Q number of antenna elements, may be considered. In this case, although there are differences according to connection methods between the B number of TXRUs and the Q number of antenna elements, a direction of a beam that may be transmitted simultaneously shall be limited to B or below.

<Analog Beamforming #2>

In an NR system, in case multiple antennas are used, the usage of a hybrid beamforming method, which is a combination of digital beamforming and analog beamforming, is rising. At this point, analog beamforming is advantageous in that it performs precoding (or combining) at an RF end, thereby reducing the number of RF chains and the number of D/A (or A/D) converters as well as achieving a performance that is proximate to digital beamforming. For simplicity, the hybrid beamforming structure may be expressed as N number of TXRUs and M number of physical channels. Accordingly, digital beamforming for L number of data layers that are to be transmitted by the transmitter may be expressed as an N by L matrix. Then, after the converted N number of digital signals pass through the TXRU so as to be converted to analog signals, analog beamforming, which is expressed as an M by N matrix, is applied thereto.

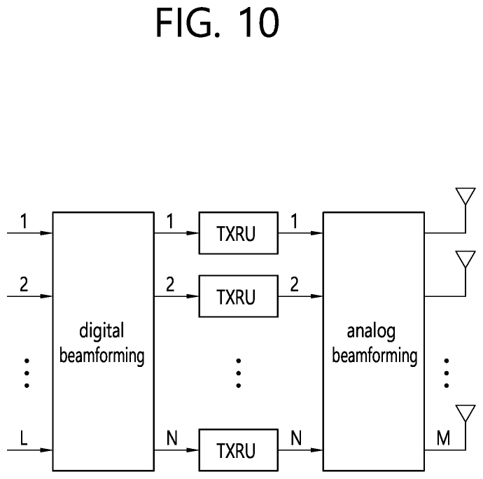

FIG. 10 is an abstract diagram of a hybrid beamforming structure in the viewpoints of the TXRU and physical antenna.

In FIG. 10, a number of digital beams is equal to L, and a number of analog beams is equal to N. Moreover, NR systems are considering a solution for supporting more efficient beamforming to a UE, which is located in a specific area, by designing the base station to be capable of changing beamforming to symbol units. Furthermore, in FIG. 10, when specific N number of TXRUs and M number of RF antennas are defined as a single antenna panel, a solution of adopting multiple antenna panels capable of having independent hybrid beamforming applied thereto is being considered in the NR system.

As described above, in case the base station uses multiple analog beams, since the analog beams that are advantageous for signal reception per UE may vary, for at least the synchronization signal, system information, paging, and so on, a beam sweeping operation is being considered. Herein, the beam sweeping operation allows the multiple analog beams that are to be applied by the base station to be changed per symbol so that all UEs can have reception opportunities.

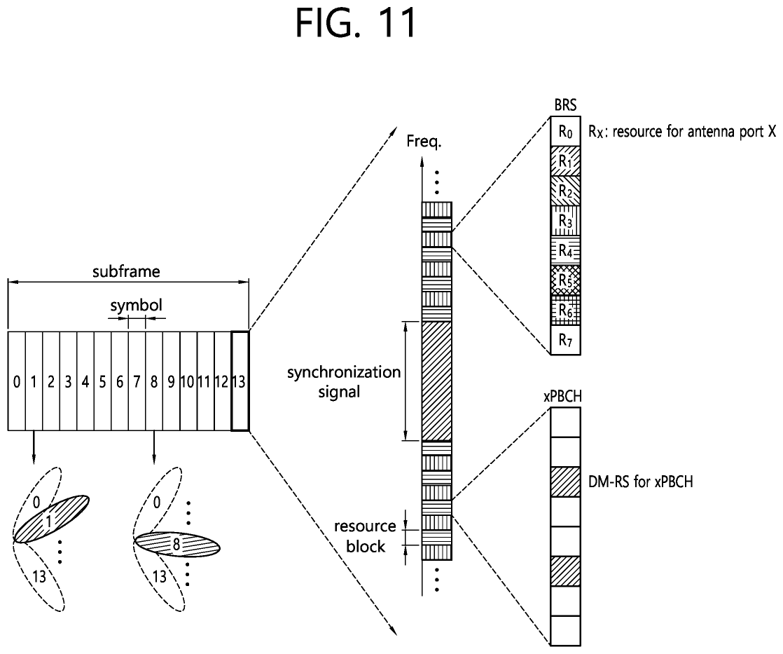

FIG. 11 is a schematic diagram of the beam sweeping operation for a synchronization signal and system information during a downlink (DL) transmission process.

In FIG. 11, a physical resource (or physical channel) through which system information of the NR system is being transmitted by a broadcasting scheme is referred to as a physical broadcast channel (xPBCH). At this point, analog beams belonging to different antenna panels within a single symbol may be transmitted simultaneously. And, in order to measure a channel per analog beam, as shown in FIG. 11, a solution of adopting a beam reference signal (beam RS, BRS), which is a reference signal (RS) being transmitted after having a single analog beam (corresponding to a specific antenna panel) applied thereto. The BRS may be defined for multiple antenna ports, and each antenna port of the BRS may correspond to a single analog beam. At this point, unlike the BRS, a synchronization signal or xPBCH may be transmitted, after having all analog beams within an analog beam group applied thereto, so as to allow a random UE to successfully receive the signal.

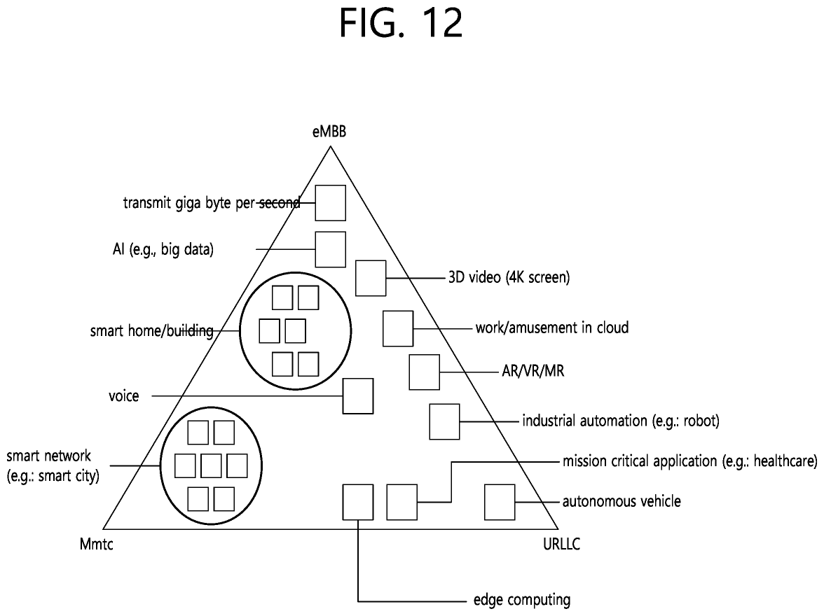

FIG. 12 shows examples of 5G usage scenarios to which the technical features of the present specification can be applied. The 5G usage scenarios shown in FIG. 12 are only exemplary, and the technical features of the present specification can be applied to other 5G usage scenarios which are not shown in FIG. 12.

Referring to FIG. 12, the three main requirements areas of 5G include (1) enhanced mobile broadband (eMBB) domain, (2) massive machine type communication (mMTC) area, and (3) ultra-reliable and low latency communications (URLLC) area. Some use cases may require multiple areas for optimization and, other use cases may only focus on only one key performance indicator (KPI). 5G is to support these various use cases in a flexible and reliable way.

eMBB focuses on across-the-board enhancements to the data rate, latency, user density, capacity and coverage of mobile broadband access. The eMBB aims ˜10 Gbps of throughput. eMBB far surpasses basic mobile Internet access and covers rich interactive work and media and entertainment applications in cloud and/or augmented reality. Data is one of the key drivers of 5G and may not be able to see dedicated voice services for the first time in the 5G era. In 5G, the voice is expected to be processed as an application simply using the data connection provided by the communication system. The main reason for the increased volume of traffic is an increase in the size of the content and an increase in the number of applications requiring high data rates. Streaming services (audio and video), interactive video and mobile Internet connectivity will become more common as more devices connect to the Internet. Many of these applications require always-on connectivity to push real-time information and notifications to the user. Cloud storage and applications are growing rapidly in mobile communication platforms, which can be applied to both work and entertainment. Cloud storage is a special use case that drives growth of uplink data rate. 5G is also used for remote tasks on the cloud and requires much lower end-to-end delay to maintain a good user experience when the tactile interface is used. In entertainment, for example, cloud games and video streaming are another key factor that increases the demand for mobile broadband capabilities. Entertainment is essential in smartphones and tablets anywhere, including high mobility environments such as trains, cars and airplanes. Another use case is augmented reality and information retrieval for entertainment. Here, augmented reality requires very low latency and instantaneous data amount.

mMTC is designed to enable communication between devices that are low-cost, massive in number and battery-driven, intended to support applications such as smart metering, logistics, and field and body sensors. mMTC aims ˜10 years on battery and/or ˜1 million devices/km². mMTC allows seamless integration of embedded sensors in all areas and is one of the most widely used 5G applications. Potentially by 2020, IoT devices are expected to reach 20.4 billion. Industrial IoT is one of the areas where 5G plays a key role in enabling smart cities, asset tracking, smart utilities, agriculture and security infrastructures.

URLLC will make it possible for devices and machines to communicate with ultra-reliability, very low latency and high availability, making it ideal for vehicular communication, industrial control, factory automation, remote surgery, smart grids and public safety applications. URLLC aims ˜1 ms of latency. URLLC includes new services that will change the industry through links with ultra-reliability/low latency, such as remote control of key infrastructure and self-driving vehicles. The level of reliability and latency is essential for smart grid control, industrial automation, robotics, drone control and coordination.

Next, a plurality of use cases included in the triangle of FIG. 12 will be described in more detail.

5G can complement fiber-to-the-home (FTTH) and cable-based broadband (or DOCSIS) as a means of delivering streams rated from hundreds of megabits per second to gigabits per second. This high speed can be required to deliver TVs with resolutions of 4K or more (6K, 8K and above) as well as virtual reality (VR) and augmented reality (AR). VR and AR applications include mostly immersive sporting events. Certain applications may require special network settings. For example, in the case of a VR game, a game company may need to integrate a core server with an edge network server of a network operator to minimize delay.

Automotive is expected to become an important new driver for 5G, with many use cases for mobile communications to vehicles. For example, entertainment for passengers demands high capacity and high mobile broadband at the same time. This is because future users will continue to expect high-quality connections regardless of their location and speed. Another use case in the automotive sector is an augmented reality dashboard. The driver can identify an object in the dark on top of what is being viewed through the front window through the augmented reality dashboard. The augmented reality dashboard displays information that will inform the driver about the object's distance and movement. In the future, the wireless module enables communication between vehicles, information exchange between the vehicle and the supporting infrastructure, and information exchange between the vehicle and other connected devices (e.g., devices accompanied by a pedestrian). The safety system allows the driver to guide the alternative course of action so that he can drive more safely, thereby reducing the risk of accidents. The next step will be a remotely controlled vehicle or self-driving vehicle. This requires a very reliable and very fast communication between different self-driving vehicles and between vehicles and infrastructure. In the future, a self-driving vehicle will perform all driving activities, and the driver will focus only on traffic that the vehicle itself cannot identify. The technical requirements of self-driving vehicles require ultra-low latency and high-speed reliability to increase traffic safety to a level not achievable by humans.

Smart cities and smart homes, which are referred to as smart societies, will be embedded in high density wireless sensor networks. The distributed network of intelligent sensors will identify conditions for cost and energy-efficient maintenance of a city or house. A similar setting can be performed for each home. Temperature sensors, windows and heating controllers, burglar alarms and appliances are all wirelessly connected. Many of these sensors typically require low data rate, low power and low cost. However, for example, real-time HD video may be required for certain types of devices for monitoring.

The consumption and distribution of energy, including heat or gas, is highly dispersed, requiring automated control of distributed sensor networks. The smart grid interconnects these sensors using digital information and communication technologies to collect and act on information. This information can include supplier and consumer behavior, allowing the smart grid to improve the distribution of fuel, such as electricity, in terms of efficiency, reliability, economy, production sustainability, and automated methods. The smart grid can be viewed as another sensor network with low latency.

The health sector has many applications that can benefit from mobile communications. Communication systems can support telemedicine to provide clinical care in remote locations. This can help to reduce barriers to distance and improve access to health services that are not continuously available in distant rural areas. It is also used to save lives in critical care and emergency situations. Mobile communication based wireless sensor networks can provide remote monitoring and sensors for parameters such as heart rate and blood pressure.

Wireless and mobile communications are becoming increasingly important in industrial applications. Wiring costs are high for installation and maintenance. Thus, the possibility of replacing a cable with a wireless link that can be reconfigured is an attractive opportunity in many industries. However, achieving this requires that wireless connections operate with similar delay, reliability, and capacity as cables and that their management is simplified. Low latency and very low error probabilities are new requirements that need to be connected to 5G.

Logistics and freight tracking are important use cases of mobile communications that enable tracking of inventory and packages anywhere using location-based information systems. Use cases of logistics and freight tracking typically require low data rates, but require a large range and reliable location information.

Hereinafter, a discussion related to power saving will be described.

The terminal's battery life is a factor of the user experience that influences the adoption of 5G handsets and/or services. Power efficiency for 5G NR terminals is not worse than at least LTE, and a study of terminal power consumption may be provided in order to identify and apply techniques and designs for improvement.

ITU-R defines energy efficiency as one of the minimum technical performance requirements of IMT-2020. According to the ITU-R report, e.g. the minimum requirements related to the technical performance of the IMT-2020 air interface, the energy efficiency of a device can be related to support for two aspects: a) efficient data transmission in the loaded case, b) low energy consumption when there is no data. Efficient data transmission in the loaded case is demonstrated by average spectral efficiency. In the absence of data, low energy consumption can be estimated by the sleep rate.

Since the NR system can support high-speed data transmission, it is expected that user data will be burst and serviced for a very short period of time. One efficient terminal power saving mechanism is to trigger the terminal for network access from the power efficiency mode. Unless there is information about network access through the terminal power saving framework, the terminal maintains a power efficiency mode such as a micro-sleep or OFF period within a long DRX period. Instead, when there is no traffic to be transmitted, the network may support the terminal to switch from the network access mode to the power saving mode (e.g., dynamic terminal switching to sleep with a network support signal).

In addition to minimizing power consumption with a new wake-up/go-to-sleep mechanism, it may be provided to reduce power consumption during network access in RRC_CONNECTED mode. In LTE, more than half of the power consumption of the terminal occurs in the connected mode. Power saving techniques should focus on minimizing the main factors of power consumption during network access, including processing of aggregated bandwidth, dynamic number of RF chains and dynamic transmission/reception time and dynamic switching to power efficiency mode. In most cases of LTE field TTI, there is no data or there is little data, so a power saving scheme for dynamic adaptation to other data arrivals should be studied in the RRC-CONNECTED mode. Dynamic adaptation to traffic of various dimensions such as carrier, antenna, beamforming and bandwidth can also be studied. Further, it is necessary to consider how to enhance the switching between the network connection mode and the power saving mode. Both network-assisted and terminal-assisted approaches should be considered for terminal power saving mechanisms.

The terminal also consumes a lot of power for RRM measurement. In particular, the terminal must turn on the power before the DRX ON period for tracking the channel to prepare for RRM measurement. Some of the RRM measurement is not essential, but consumes a lot of terminal power. For example, low mobility terminals do not need to be measured as frequently as high mobility terminals. The network may provide signaling to reduce power consumption for RRM measurement, which is unnecessary for the terminal. Additional terminal support, for example terminal state information, etc., is also useful for enabling the network to reduce terminal power consumption for RRM measurement.

Accordingly, there is a need for research to identify the feasibility and advantages of a technology that enables the implementation of a terminal capable of operating while reducing power consumption.

Hereinafter, UE power saving schemes will be described.

For example, the terminal power saving techniques may consider a power saving signal/channel/procedure for triggering terminal adaptation to traffic and power consumption characteristics, adaptation to frequency changes, adaptation to time changes, adaptation to the antenna, adaptation to the DRX configuration, adaptation to terminal processing capabilities, adaptation to obtain PDCCH monitoring/decoding reduction, terminal power consumption adaptation and a reduction in power consumption in RRM measurement.

Regarding adaptation to the DRX configuration, a downlink shared channel (DL-SCH) featuring support for terminal discontinuous reception (DRX) for enabling terminal power saving, PCH featuring support for terminal DRX enabling terminal power saving (here, the DRX cycle may be indicated to the terminal by the network) and the like may be considered.

Regarding adaptation to the terminal processing capability, the following techniques may be considered. When requested by the network, the terminal reports at least its static terminal radio access capability. The gNB may request the ability of the UE to report based on band information. If allowed by the network, a temporary capability limit request may be sent by the terminal to signal the limited availability of some capabilities (e.g., due to hardware sharing, interference or overheating) to the gNB. Thereafter, the gNB can confirm or reject the request. Temporary capability limitations must be transparent to 5GC. That is, only static functions are stored in 5GC.

Regarding adaptation to obtain PDCCH monitoring/decoding reduction, the following techniques may be considered. The UE monitors the PDCCH candidate set at a monitoring occasion configured in one or more CORESETs configured according to a corresponding search space configuration. CORESET consists of a set of PRBs having a time interval of 1 to 3 OFDM symbols. Resource units REG and CCE are defined in CORESET, and each CCE consists of a set of REGs. The control channel is formed by a set of CCEs. Different code rates for the control channel are implemented by aggregating different numbers of CCEs. Interleaved and non-interleaved CCE-REG mapping is supported in CORESET.

Regarding the power saving signal/channel/procedure for triggering terminal power consumption adaptation, the following technique may be considered. In order to enable reasonable terminal battery consumption when carrier aggregation (CA) is configured, an activation/deactivation mechanism of cells is supported. When one cell is deactivated, the UE does not need to receive a corresponding PDCCH or PDSCH, cannot perform a corresponding uplink transmission, and does not need to perform a channel quality indicator (CQI) measurement. Conversely, when one cell is activated, the UE must receive the PDCH and PDCCH (if the UE is configured to monitor the PDCCH from this SCell), and is expected to be able to perform CQI measurement. The NG-RAN prevents the SCell of the secondary PUCCH group (the group of SCells in which PUCCH signaling is associated with the PUCCH of the PUCCH SCell) from being activated while the PUCCH SCell (secondary cell composed of PUCCH) is deactivated. The NG-RAN causes the SCell mapped to the PUCCH SCell to be deactivated before the PUCCH SCell is changed or removed.

When reconfiguring without mobility control information, the SCell added to the set of serving cells is initially deactivated, and the (unchanged or reconfigured) SCells remaining in the set of serving cells do not change the activate state (e.g. active or inactive).

SCells are deactivated when reconfiguring with mobility control information (e.g., handover).

In order to enable reasonable battery consumption when BA (bandwidth adaptation) is configured, only one uplink BWP and one downlink BWP or only one downlink/uplink BWP pair for each uplink carrier may be activated at once in the active serving cell, and all other BWPs configured in the terminal are deactivated. In deactivated BWPs, the UE does not monitor the PDCCH and does not transmit on the PUCCH, PRACH and UL-SCH.

For BA, the terminal's reception and transmission bandwidth need not be as wide as the cell's bandwidth and can be adjusted: the width can be commanded to change (e.g. shrink during periods of low activity to save power), position in the frequency domain can be moved (e.g. to increase scheduling flexibility), the subcarrier spacing can be ordered to change (e.g., to allow different services). A subset of the total cell bandwidth of a cell is referred to as a bandwidth part (BWP), the BA is obtained by configuring the BWP(s) to the UE and knowing that it is currently active among the BWPs configured to the UE. When the BA is configured, the terminal only needs to monitor the PDCCH on one active BWP. That is, there is no need to monitor the PDCCH on the entire downlink frequency of the cell. The BWP inactive timer (independent of the DRX inactive timer described above) is used to convert the active BWP to the default BWP: tyhe timer is restarted when the PDCCH decoding succeeds, switching to the default BWP occurs when the timer expires.

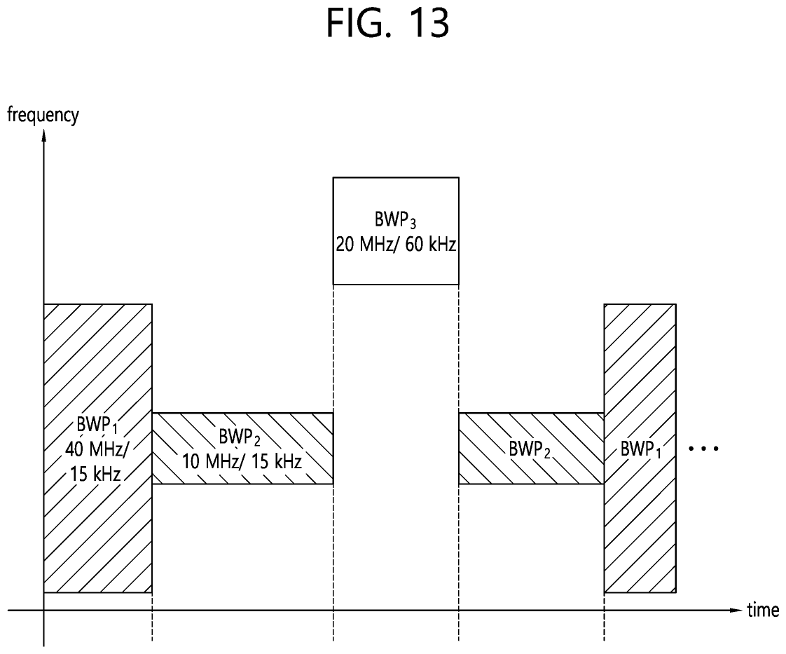

FIG. 13 illustrates a scenario in which three different bandwidth parts are configured.

FIG. 13 shows an example in which BWP1, BWP2, and BWP3 are configured on time-frequency resources. BWP1 has a width of 40 MHz and a subcarrier spacing of 15 kHz, BWP2 has a width of 10 MHz and a subcarrier spacing of 15 kHz, and BWP3 may have a width of 20 MHz and a subcarrier spacing of 60 kHz. In other words, each of the bandwidth parts may have different widths and/or different subcarrier spacings.

Regarding the power consumption reduction in RRM measurement, the following technique may be considered. If two measurement types are possible, the RRM configuration may include the beam measurement information related to the SSB(s) (for layer 3 mobility) and the CSI-RS(s) for the reported cell(s). In addition, when CA is configured, the RRM configuration may include a list of best cells on each frequency for which measurement information is available. In addition, the RRM measurement information may include beam measurement for listed cells belonging to the target gNB.

The following techniques can be used in various wireless access systems such as CDMA, FDMA, TDMA, OFDMA, SC-FDMA, and the like. CDMA may be implemented with a radio technology such as Universal Terrestrial Radio Access (UTRA) or CDMA2000. TDMA may be implemented with a radio technology such as Global System for Mobile communications (GSM)/General Packet Radio Service (GPRS)/Enhanced Data Rates for GSM Evolution (EDGE). OFDMA may be implemented with a wireless technology such as IEEE 802.11 (Wi-Fi), IEEE 802.16 (WiMAX), IEEE 802-20, and Evolved UTRA (E-UTRA). UTRA is a part of Universal Mobile Telecommunications System (UMTS). 3rd Generation Partnership Project (3GPP) Long Term Evolution (LTE) is a part of Evolved UMTS (E-UMTS) using E-UTRA, and Advanced (LTE-A)/LTE-A pro is an evolved version of 3GPP LTE. 3GPP New Radio or New Radio Access Technology (NR) is an evolved version of 3GPP LTE/LTE-A/LTE-A pro.

For clarity, the description is based on a 3GPP communication system (e.g., LTE-A, NR), but the technical idea of the present specification is not limited thereto. LTE refers to technology after 3GPP TS 36.xxx Release 8. In detail, LTE technology after 3GPP TS 36.xxx Release 10 is referred to as LTE-A, and LTE technology after 3GPP TS 36.xxx Release 13 is referred to as LTE-A pro. 3GPP NR refers to the technology after TS 38.xxx Release 15. LTE/NR may be referred to as a 3GPP system. “xxx” means standard document detail number. LTE/NR may be collectively referred to as a 3GPP system. Background art, terms, abbreviations, and the like used in the description of the present specification may refer to matters described in standard documents published before the present specification.

Hereinafter, the proposal of the present specification will be described in more detail.

Additional advantages, objects and features of the present specification will be partially described in the following description, it will be apparent to one of ordinary skill in the art or will be able to learn in part from the practice of this specification upon review of the following. Objects and other advantages of the present specification can be realized and achieved by the accompanying drawings, as well as the structures particularly pointed out in the claims and claims of the present specification.

If the reception performance of the corresponding CORESET is degraded in units of CORESET, the procedure for changing the Transmission Configuration Indication (TCI) information of CORESET or CORESET, or the related measurement report and so on is not currently defined, and this may mean that the network cannot know the reception performance for each CORESET of a specific UE.

In the above case, it can be negative in that monitoring for the PDCCH must be continuously performed although the beam configured in the existing CORESET cannot be received due to the mobility of the UE etc. and it can lead to unnecessary resource waste on the network side.

Accordingly, in this specification, in order to solve the above problems, the specification proposes features for implementing a method and apparatus for efficiently performing control channel transmission/reception by performing measurement on each CORESET and reporting on a low quality CORESET.

Hereinafter, an example of a method of transmitting a report on a measurement result will be described with reference to the drawings. The following drawings were created to explain a specific example of the present specification. Since the names of specific devices described in the drawings or the names of specific signals/messages/fields are presented by way of example, the technical features of the present specification are not limited to the specific names used in the following drawings.

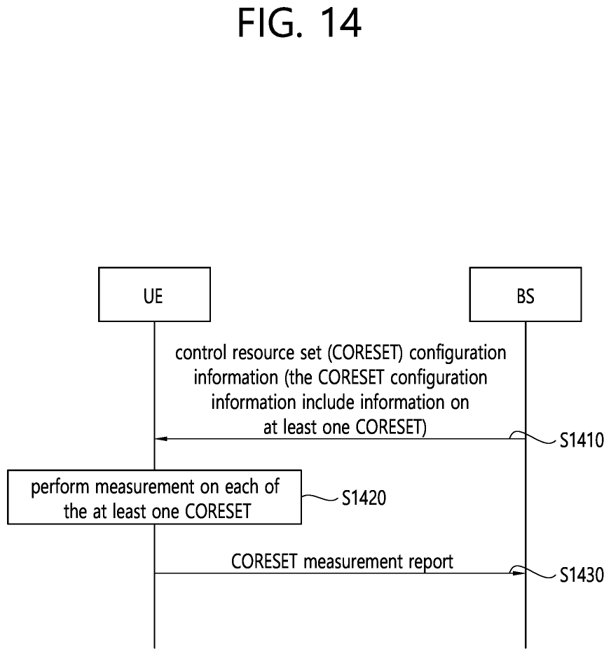

FIG. 14 is a flowchart of a method for transmitting a report on a measurement result according to an embodiment of the present specification.

According to FIG. 14, the UE may receive control resource set (CORESET) configuration information from the base station (S1410). Here, the CORESET configuration information may include information on at least one CORESET.

The UE may perform measurement on each of the at least one CORESET (S1420).

Here, although it is described in FIG. 14 that the UE performs measurement on at least one CORESET, this specification is not intended to suggest that the UE performs measurement only on the CORESET. That is, as will be described in a more specific embodiment of the present specification to be described later, the feature in which the UE performs measurement on a search space (SS) set also corresponds to an example provided in the present specification.

The UE may transmit a CORESET measurement report to the base station based on the measurement result (S1430).

Here, although it is described in FIG. 14 that the UE transmits at least a CORESET measurement report, this specification is not intended to suggest that the UE transmits a measurement report only for CORESET. That is, as will be described in a more specific embodiment of the present specification to be described later, the feature in which the UE transmits a specific report for a search space (SS) set also corresponds to an example provided in the present specification.

For example, the UE may perform the measurement for a transmission configuration indication (TCI) associated with each of the at least one CORESET.

For example, the CORESET measurement report may include low quality COREST information, the low quality CORESET information may be information for a specific CORESET having a result of a measurement lower than a first threshold value among the at least one CORESET.

Here, for example, the UE may skip monitoring for the specific CORESET. Here, for example, the UE may skip the monitoring from a first monitoring occasion of the specific CORESET after a time of transmitting the CORESET measurement report or after a certain time has elapsed since the time of transmitting the CORESET measurement report. Here, for example, the UE may receive a response for the CORESET measurement report from the base station, the UE may skip the monitoring from a time of receiving the response or after a certain time has elapsed since the time of receiving the response. Here, for example, based on the result of the measurement of the specific CORESET being greater than or equal to a second threshold, the UE may transmit a report for restarting the monitoring on the specific CORESET to the base station. Here, for example, the UE may restart the monitoring for the specific CORESET after a certain time has elapsed since transmitting the CORESET measurement report.

For example, although it will be described in more detail in the configuration for reference resource and control channel CSI measurement to be described later, the UE may transmit a report of physical downlink control channel (PDCCH) channel state information (CSI) for the at least one CORESET.

Here, for example, based on the UE transmitting a report for a preferred aggregation level (AL) to the base station, a reference downlink control information (DCI) size to which the preferred AL is applied may be a DCI size monitored by a specific search space (SS) set among at least one SS set associated with the at least one CORESET.

Hereinafter, the example of FIG. 14 will be described in more detail.

<Low Quality Report for CORESET Deactivation>

As an analog beam is introduced in the current NR system, beam-specific measurement is defined in various ways.

For example, a reference signal (RS) for beam management may be configured for a beam management procedure, and the UE performs measurement on the configured RS for beam management and it may report the best N beam(s) (where N may be configured by the network).

This may be interpreted for the purpose of adapting the beam allocated to the UE by the network based on the preferred (or strong) beam information reported by the UE.

On the other hand, a procedure called beam failure recovery may be performed in order to determine whether a link fails for all beams allocated to the UE. To this end, the network indicates the RS for determining whether the beam fails, and the UE proceeds with the beam failure recovery procedure when all of the corresponding RSs do not reach a certain level.

In the above-mentioned beam measurement method, each procedure is defined for a case in which a beam having high quality is reported or a case in which it is difficult to receive all configured beams.

On the other hand, in control channel monitoring, beam information is known to the UE by TCI information of CORESET. That is, when monitoring each CORESET, the TCI information of each CORESET may be configured in the CORESET configuration as information for configuring the Rx beam of the UE.

On the other hand, even considering the above-mentioned beam-related measurements and TCI information of CORESET, if the reception performance of the corresponding CORESET is degraded by the CORESET unit, the procedure for changing the TCI information of CORESET or for changing the CORESET, or related measurement report etc. is not currently defined, and this may mean that the network cannot know the reception performance degradation for each CORESET of a specific UE.

In the above case, it can be negative in that monitoring for the PDCCH must be continuously performed although the beam configured in the existing CORESET cannot be received due to the mobility of the UE, etc., and it can lead to unnecessary resource waste on the network side.

In this specification, in order to solve the above problem, a method for implementing efficient control channel transmission and reception by performing measurement on each CORESET and reporting on a low quality CORESET is proposed.

1. Report Low Quality CORESET (or Associated (Associated) TCI)

The UE measures the TCI associated with the CORESET that is currently configured or performs PDCCH monitoring, and reports the CORESET that is less than or equal to a specific threshold as a result of the measurement or report the TCI for the corresponding CORESET.

More specifically, the UE can receive up to three CORESETs per BWP configured (configure), the antenna port quasi co-location information that the UE should assume when receiving the CORESET is included in each CORESET configuration, and the information is provided in the form of TCI-State. This may be used as information necessary for Rx beam configuration of the UE, and each TCI-state may have the form of SSB, CSI-RS, TRS, or the like.

For the application of this specification, the UE may perform measurement on the TCI state associated with the configured CORESET. The measurement may reuse measurement results performed as part of beam management, beam failure recovery, radio link monitoring or the like.

For example, in general, because a radio link monitoring determines the availability of that link based on measurements on a control channel, measurement can be performed based on the TCI state associated with the CORESET configured by the network.

This specification may include reusing the measurement results included in the RLM procedure.

After performing the measurement, the UE may determine the quality for each CORESET based on a specific threshold, etc., and a CORESET index and/or a measurement result may be reported to the network for CORESET having a measurement result lower than the corresponding threshold value. In this case, the threshold value may be a value which is pre-defined or indicated through higher layer signaling of the network.

In addition, the report may also include a L1 signaling using an upper message in PUSCH transmission, etc. or using PUCCH, etc.

That is, the UE performs measurement for each CORESET that is configured (or performs monitoring), and when the measurement result does not reach a certain level, corresponding CORESET and/or measurement results may be reported (via a higher layer message, etc.).

In another method, resources for periodic/aperiodic reporting are allocated by the network, information on low quality CORESET (or associated search space set(s)) may be reported through the corresponding resource.

2. Measurement Resource(s)

Resources for measurement and/or reporting proposed in this specification may be independently configured, or may use previously configured resources (e.g., beam management, beam failure recovery, radio link monitoring). In addition, measurement using a resource associated with a resource defined as a TCI state in the CORESET configuration may also be effective as a measurement for the present specification.

For example, if the TCI state is configured to “CSI-RS#x” in the configuration of a specific CORESET and the source of CSI-RS#x is defined as SSB#y in the TCI state indicated by RRC signaling, measurement of the corresponding CORESET may be performed using SSB#y as well as CSI-RS#x.

3. Skip Monitoring of Reported CORESET

Through the above specification, the UE may report a low quality CORESET to the network. Thereafter, the UE may skip monitoring of the reported CORESET (or monitoring of the search space set associated with the corresponding CORESET). When monitoring is skipped without a corresponding report, since the network does not recognize whether monitoring of the UE is skipped, a case in which the network transmits the PDCCH to the corresponding CORESET (or associated search space set(s)) may occur.

The application time of monitoring skip due to low quality may be as follows.

(1) from the first monitoring occasion of the corresponding CORESET (or associated search space set(s)) after the reporting time point;

(2) after a certain time (e.g., X slot(s)) since the reporting point; and/or

(3) When the response (e.g., ACK/NACK) to the report is defined, monitoring skip due to low quality may be applied from a time point at which the corresponding response is received or a predetermined time after the reception time point.

Meanwhile, in the method of transmitting the ACK/NACK of (3), the network may inform the UE by including a response for the report in the DCI transmitted by the unreported CORESET. To this end, an X bit (e.g., 1 bit) may be added to a specific DCI (e.g., non-fallback DCI).

In addition, if the measurement result for CORESET that has been skipped monitoring is improved and exceeds a specific value, the UE may transmit the corresponding result or a report on restart of monitoring to the network, after reporting, monitoring of the corresponding CORESET can be restarted after a certain time. In this case, the method proposed above may be used for the certain time.

In addition, if the CORESET configuration is changed by the network after the monitoring skip and monitoring for the corresponding CORESET is not instructed, the monitoring of the corresponding CORESET can be ignored even if the measurement result is improved.

In addition, a threshold value for skipping monitoring and a threshold value for resuming monitoring may be configured differently (For example, a threshold value for monitoring skip may be configured to be lower than a threshold value for monitoring resumption).

In addition, if CORESET reset (configure) is not instructed from the network even after reporting for monitoring skip, and/or if the measurement result for the corresponding CORESET is consistently below the threshold, the UE may report the measurement result for the corresponding CORESET and/or whether monitoring is skipped, to the network after a certain period of time, again.

4. Relationship between low quality monitoring skip and BD/CCE limit

In addition, in order to efficiently use the monitoring capability of the UE, CORESET (or associated search space set(s)) that is skipped monitoring due to low quality may be applied before blind decoding (BD)/control channel element (CCE) limit count.

This can be interpreted as applying the BD/CCE limit for CORESET (or associated search space set(s)) that performs actual monitoring after determining to skip monitoring for a specific CORESET (or associated search space set) due to low quality.

On the other hand, after applying the BD/CCE limit to maximize the power saving gain, it may determine to skip monitoring for CORESET (or associated search space set(s)) due to low quality.

The above two methods may be determined by the network (for example, if a power saving mode is configured or a power saving scheme is used, the latter (low quality monitoring skip after applying BD/CCE limit) method is applied), or whether to be applied in a predefined manner (e.g., the former or the latter is applied) may be determined.

The examples in FIG. 14 described so far are summarized and described again with reference to the drawings, it may be as follows.

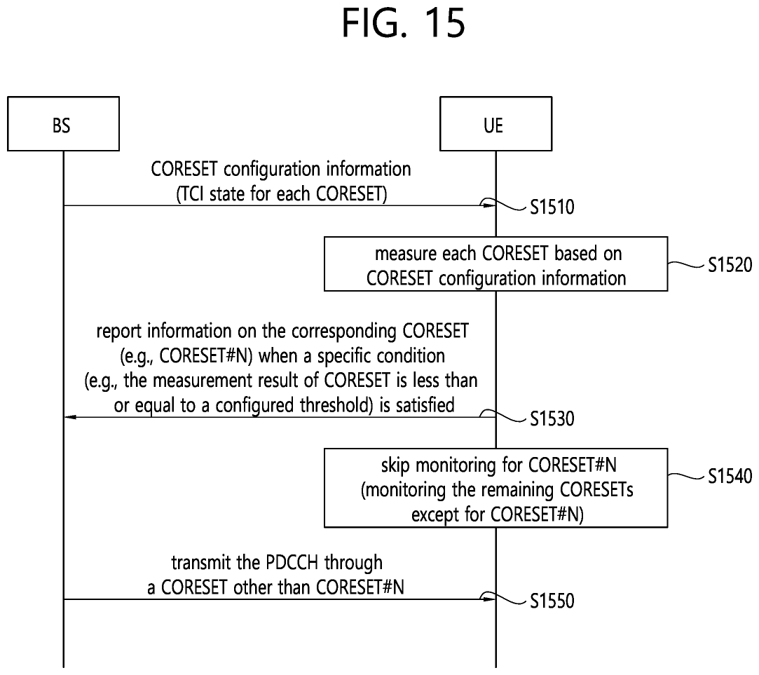

FIG. 15 is a flowchart of a quality report for CORESET deactivation according to an embodiment of the present specification.

According to FIG. 15, the UE may receive CORESET configuration information (possible to include a TCI state for each CORESET) (S1510). Here, a more specific example of CORESET configuration information received by the UE is the same as described above (and/or will be described later), and thus, repeated description of overlapping content will be omitted for convenience of description.

The UE may measure each CORESET based on CORESET configuration information (S1520). Here, since a more specific example in which the UE performs measurement for each CORESET is the same as described above (and/or will be described later), repeated description of overlapping content will be omitted for convenience of description.

When a specific condition (e.g., the measurement result of CORESET is less than or equal to a configured threshold) is satisfied, the UE may report information on the corresponding CORESET (e.g., CORESET#N) (S1530). Here, since a more specific example of reporting information on CORESET is the same as described above (and/or will be described later), repeated description of overlapping content will be omitted for convenience of description.

The UE may skip monitoring for CORESET#N (monitoring the remaining CORESETs except for CORESET#N) (S1540). Here, since a more specific example in which the UE skips monitoring is the same as described above (and/or will be described later), repeated description of overlapping content will be omitted for convenience of description.

The UE may receive the PDCCH through a CORESET other than CORESET#N (S1550). Here, a more specific example in which the UE receives the PDCCH is the same as described above (and/or will be described later), and thus repeated description of overlapping content will be omitted for convenience of description.

Returning to FIG. 14 again, the embodiment in FIG. 14 will be described as follows.

<Antenna Port Quasi-Co-Location Information of CORESET for PS-PDCCH>

As stated above, in the CORESET configuration for the control channel in the NR, antenna port quasi-co-location information assumed when the corresponding CORESET is received is included.

Power saving scheme related information may be transmitted using a power saving channel (hereinafter referred to as PS-PDCCH), CORESET for monitoring the corresponding PS-PDCCH may use a UE-specific CORESET to reflect the traffic pattern, mobility, etc. of each UE. In this case, the antenna port quasi-co-location information of the corresponding CORESET may be determined as follows.

Option 1) Configure in CORESET configuration

Like the existing CORESET, the antenna port quasi-co-location information of the corresponding CORESET can be configured in the CORESET configuration.

Option 2) TCI-less CORESET

The PS-PDCCH may serve to adapt to environmental changes such as mobility of the UE, in this case, there may be no reason to fix the TCI of the CORESET for monitoring the PS-PDCCH to one.

Therefore, in this specification, antenna port quasi-co-location information for CORESET monitoring PS-PDCCH is not defined in CORESET configuration, but is proposed to be determined according to the situation (or even if TCI is specified in CORESET configuration, the state of the TCI associated with the corresponding CORESET may be changed without additional RRC/MAC signaling).

For example, the TCI of CORESET for PS-PDCCH may be determined in association with the TCI of CORESET #0 monitored by the corresponding UE. This also means that the condition (e.g., the most recent TCI status among TCI status related to RACH procedure or TCI signaled by MAC CE is assumed as the TCI of the corresponding CORESET) for changing the TCI of CORESET #0 can also be applied to CORESET for PS-PDCCH.

On the other hand, the PS-PDCCH CORESET may be configured in common to the UE group in order to simultaneously deliver the power saving scheme configuration for a plurality of UEs. In this case, most simply, the CORESET and SS set of the PS-PDCCH may be determined in association with the SS set #0 monitored by each UE.

For example, when PS-PDCCH is monitored in CORESET #0 or CORESET having the same characteristics as CORESET #0 (i.e., linked to SSB), a monitoring occasion may be determined in connection with the location of the SSB for the search space set for PS-PDCCH monitoring, the SSB associated with the corresponding CORESET/search space set may be determined as the most recent value among the TCI derived by the RACH procedure and the TCI signaled by the MAC CE.

For each UE configured to monitor PS-PDCCH, a CORESET/search space set is determined according to the SSB associated with the UE, and a reception operation may be performed based on the SSB associated with the monitoring occasion of the corresponding search space set. At this time, each UE may determine whether it is a PS -PDCCH indicated to the UE based on a specific field in the PS-PDCCH or the RNTI of the PS-PDCCH or scrambling of the DMRS for the PS-PDCCH.

<BD/CCE Limit for PS-PDCCH>

When a search space set for PS-PDCCH is UE-specifically indicated and the corresponding search space set operates as a USS (UE-specific search space), a case may occur in which monitoring for the PS-PDCCH is skipped due to the existing BD/CCE limit-related operation.

For reference, the existing operation means that SS set level dropping is performed until the limit is satisfied according to a certain rule (e.g., CSS (common search space) is not skipped, and for USS, lower SS set index has higher priority) when the number of blind decodes and/or the number of CCEs of the search space set(s) that need to be monitored in a specific slot exceeds the limit and a limit for the number of blind decodes that the UE can perform and the number of non-overlapped CCEs performing channel estimation are defined in advance for each slot.

When the SS set for monitoring the PS-PDCCH is USS, if the BD and/or CCE limit is exceeded in a specific slot, a probability of dropping the SS set for monitoring the PS-PDCCH may occur.

Since some of the power saving schemes may change the monitoring configuration of the UE, etc., the search space drop due to the BD/CCE limit may affect the power saving performance and demodulation performance of the corresponding UE. Therefore, in this specification, it is proposed that the search space set for the PS-PDCCH is not dropped by the BD/CCE limit.

This may be implemented in such a way that it is assumed that the corresponding search space set has the highest priority in SS set dropping, or that the corresponding search space set is guaranteed not to be dropped by the network.

As an example, in the non-fallback DCI, an indication of the minimum applicable KO of cross-slot scheduling (using an additional field), an indication of a dormancy behavior for the SCell, etc. may be transmitted, and since non-fallback DCI can be transmitted through USS, monitoring may be skipped when the BD/CCE limit is exceeded.

In this case, the UE may assume that the SS set is excluded from the monitoring skip, a monitoring skip for some of the USS set or CSS having an index lower than that of the corresponding SS set may be considered.

On the other hand, the above suggested methods such as performing measurement on the TCI state configured in each CORESET, reporting a low-quality CORESET based on the measurement result, and skipping monitoring in the corresponding CORESET.

Regarding the measurement report among the above, the following may be additionally considered, and may be applied to the control channel CSI measurement proposed below as a reporting method.

A measurement of the control channel quality may be triggered aperiodically by the network. The network may instruct (through higher layer signaling or L1 signaling, etc.) to measure and report the control channel quality, the indication may include CORESET(s) and/or SS set(s) to perform measurement.

This may indicate some or all of the configured CORESET/SS sets, or may indicate some or all of a predefined (or indicated) reference resource(s).

Additionally, aperiodic control channel quality measurement/reporting may be indicated together with an aperiodic CSI triggering message for the existing PDSCH, reporting may also be performed by being included in the same PUCCH/PUSCH.

In addition, the reference resource for quality measurement may be defined as a CORESET and/or SS set for monitoring DCI triggering the corresponding measurement.

<Configuration for Reference Resource and Control Channel CSI Measurement>

The quality measurement for the control channel may be implemented by performing CSI measurement defined for the PDSCH on the control channel. In the control channel (unlike the data channel), configuration may be instructed for each CORESET, each configuration may require a different decoding method, such as whether interleaving, REG bundle size, CCE-to-REG mapping method, etc., or each configuration can be defined for a different purpose.

In this specification, a method for measuring PDCCH CSI is proposed. The methods proposed below may be implemented alone or in combination.

Option 1) CORESET-specific PDCCH CSI

As stated above, each CORESET can have various characteristics according to the configuration indicated by the network, this may mean that decoding performance may be different for each CORESET. Therefore, PDCCH CSI may be measured and reported for each CORESET (or, in order to reduce reporting overhead, etc., only CSI for a specific CORESET (e.g., CORESET to which a USS set is linked) may be measured and/or reported).

Decoding performance indicators in the corresponding CORESET may be reported in various ways, such as Signal-to-interference-plus-noise ratio (SINR), coding rate, aggregation level (AL), Reference Signals Received Power (RSRP), Reference Signal Received Quality (RSRQ), etc., since multiple sets of search spaces can be associated with CORESET, channel quality may be reported in the form of a coding rate so that the network can apply that report to all search space set.

When reporting a preferred AL, the reference DCI size to which the AL is applied needs to be defined, this can designate the DCI size monitored by a specific SS set among the SS sets linked to the corresponding CORESET as the reference size (This may be predefined (e.g., the SS set with the lowest (or highest) SS set ID among the associated SS sets) or may be indicated by the network).

Option 2) SS set-specific PDCCH CSI

One CORESET can be associated with multiple SS sets, this means that the corresponding CORESET is monitored with different monitoring periodicity and monitoring pattern.

Accordingly, each SS set associated with the corresponding CORESET may have different interference characteristics, for this reason, there may be cases in which it is difficult to apply the channel quality of the CORESET unit to some of the SS sets associated with the corresponding CORESET. Therefore, the channel quality for the control channel can be measured and/or reported in units of SS sets, in this case, the unit of channel quality may be defined in a manner such as SINR, coding rate, AL, RSRP, RSRQ.

Option 3) UE-specific PDCCH CSI

In order to reduce the complexity of the PDCCH CSI, only one PDCCH CSI may be measured and/or reported for each UE. In this case, a reference resource for PDCCH CSI measurement needs to be defined, and the following scheme may be considered.

Alt 1) Among the currently configured CORESET/SS sets, a specific CORESET/SS set is considered as a reference.

A specific CORESET and/or SS set among CORESET and/or SS sets configured to the UE may be defined as a reference resource for control channel quality measurement, the reference resource may be determined by a predefined definition or an instruction of a network.

For example, when a reference resource is defined by pre-definition, a combination of the SS set having the lowest index among the USS set (or the CSS set or the entire SS set) and the CORESET associated with the SS set may be regarded as a reference resource.

The DCI size for deriving the quality measurement result may be predefined as the DCI size monitored on the reference resource (or a predefined value regardless of the reference resource) or may be indicated by the network. In this case, since the UE measures the quality for a specific resource among the configured CORESET and/or SS set, there is an advantage that the channel quality of the UE can be more accurately reflected.

Alt 2) Determine the reference resource configuration (configure) by predefined or network instructions

DCI size, CCE-to-REG mapping, REG bundle size, RS type (narrowband/wideband RS), CORESET size (freq./time), some or all of the TCI status is given as information for a reference resource through predefined or network indication, the UE may measure and/or report the control channel quality based on the corresponding information.

For example, interleaving is applied in CORESET of a specific size and specific TCI state, the REG bundle size is 6, the RS type assumes a narrowband RS, and the DCI size may consider the size of a fallback DCI, it is possible to report an AL (or an effective coding rate) that can satisfy 1% of the PDCCH BLER in the corresponding condition.

Additionally, when Alt 1 and 2 above are applied, when the channel quality value in the reference resource is applied to each CORESET and/or SS set, an offset value that the network can assume may be additionally reported.

For example, if it reports that the preferred AL is 4 for the reference resource, the UE may report the offset between the corresponding value and the channel quality in the actual SS set, the reporting overhead can be reduced through a method of reporting only when the CORESET and/or SS set configuration is changed.

The examples (In particular, an example of a configuration for reference resource and control channel CSI measurement) in FIG. 14 described so far are summarized and described again with reference to the drawings, it may be as follows.

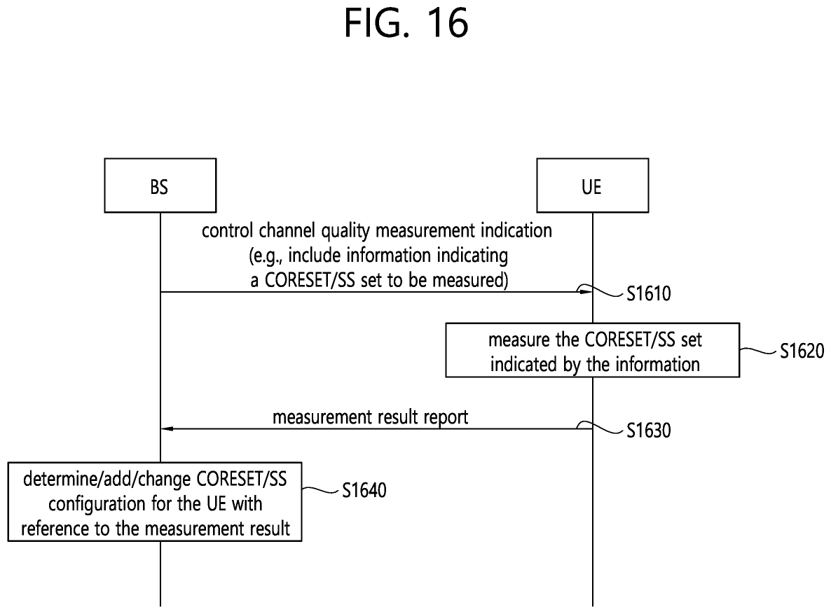

FIG. 16 is a flowchart of a method for configuring a reference resource and a control channel CSI measurement according to an embodiment of the present specification.

According to FIG. 16, the UE may receive a control channel quality measurement indication (e.g., may include information indicating a CORESET/SS set to be measured) from the base station (S1610). Here, a more specific example of the control channel quality measurement indication received by the UE is the same as described above (and/or will be described later), and thus, repeated description of overlapping content will be omitted for convenience of description.

The UE may measure the CORESET/SS set indicated by the information (S1620). Here, a more specific example of the measurement of the CORESET/SS set is the same as described above (and/or will be described later), and thus, repeated description of overlapping content will be omitted for convenience of description.

Thereafter, the UE may transmit a measurement result report to the base station (S1630). Here, since a more specific example of the measurement result report transmitted by the UE is the same as described above (and/or will be described later), repeated description of overlapping content will be omitted for convenience of description.

The base station may determine/add/change CORESET/SS configuration for the UE with reference to the measurement result (S1640). Here, a more specific example of determining/adding/changing the CORESET/SS configuration for the UE is the same as described above (and/or to be described later), for convenience of description, repeated descriptions of overlapping content will be omitted.

Here, the example of FIG. 16 may correspond to an example of the example of FIG. 14 as described above, and the example of FIG. 16 may be combined with the example of FIG. 15 (unless content contradicts each other).

Meanwhile, although the example of FIG. 16 is described as the example of FIG. 14, the example of FIG. 16 may operate separately from the example of FIG. 14 or the example of FIG. 15.

An example of the embodiments of the present specification described so far may be described again from the viewpoint of the UE as follows.

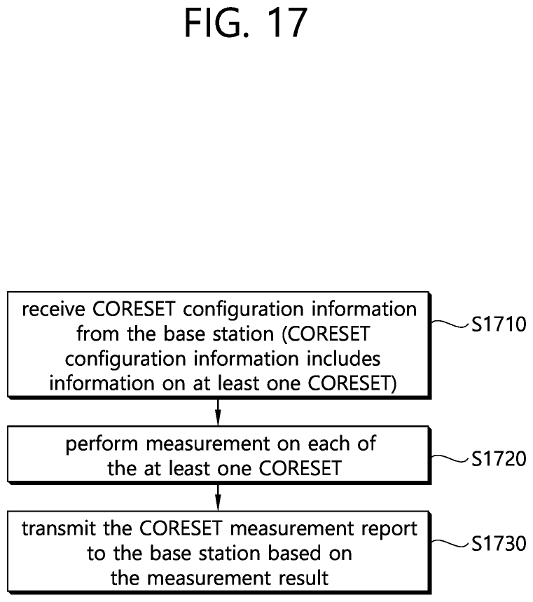

FIG. 17 is a flowchart of a method of transmitting a report on a measurement result from the viewpoint of a UE, according to an embodiment of the present specification.

Referring to FIG. 17, the UE may receive CORESET configuration information from the base station (S1710). Here, the CORESET configuration information may include information on at least one CORESET.

The UE may perform measurement on each of the at least one CORESET (S1720).

The UE may transmit the CORESET measurement report to the base station based on the measurement result (S1730).

From the viewpoint of the UE, a more specific example of a method of transmitting a report on a measurement result is the same as described above, and thus repeated description will be omitted for convenience of description.

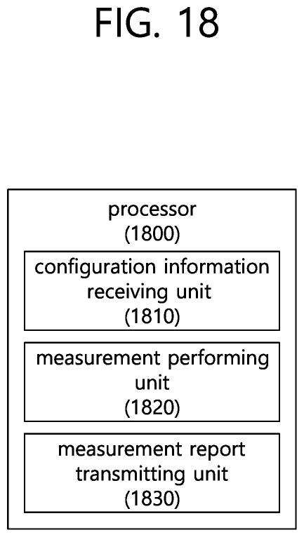

FIG. 18 is an example of a block diagram of an apparatus for transmitting a report on a measurement result from the viewpoint of a UE, according to an embodiment of the present specification.

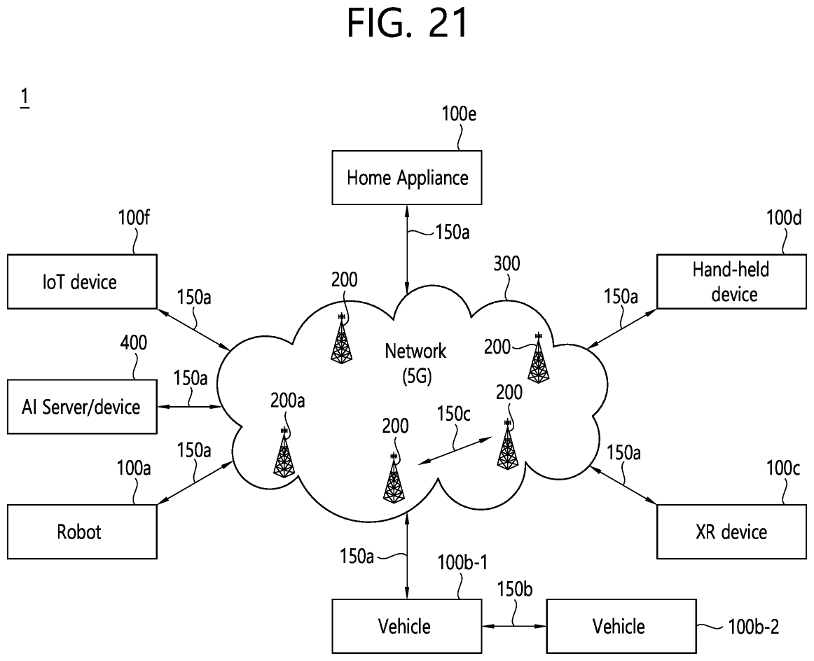

Referring to FIG. 18, the processor 1800 may include a configuration information receiving unit 1810, a measurement performing unit 1820, and a measurement report transmitting unit 1830. Here, the processor 1800 may be a processor in FIGS. 21 to 27 to be described later.

The configuration information receiving unit 1810 may be configured to receive CORESET configuration information from the base station. Here, the CORESET configuration information may include information on at least one CORESET.

The measurement performing unit 1820 may be configured to perform measurement on each of the at least one CORESET.

The measurement report transmitting unit 1830 may be configured to transmit the CORESET measurement report to the base station based on the measurement result.

From the viewpoint of the UE, a more specific example of a method of transmitting a report on a measurement result is the same as described above, and thus repeated description will be omitted for convenience of description.

Meanwhile, the disclosure of the present specification may be implemented as a chipset or a recording medium.

According to one embodiment, an apparatus may be an apparatus comprising at least one memory and at least one processor being operatively connected to the at least one memory, the at least one processor configured to control a transceiver to receive, from a base station, control resource set (CORESET) configuration information, the CORESET configuration information including information for at least one CORESET, perform a measurement for each of the at least one CORESET and control the transceiver to transmit, to the base station, a CORESET measurement report based on a result of the measurement.

According to another embodiment, a CRM may be at least one computer readable medium (CRM) including instructions being executed by at least one processor, wherein the at least one processor is configured to control a transceiver to receive, from a base station, control resource set (CORESET) configuration information, the CORESET configuration information including information for at least one CORESET, perform a measurement for each of the at least one CORESET and control the transceiver to transmit, to the base station, a CORESET measurement report based on a result of the measurement.

An example of the embodiments of the present specification described so far may be described again from the viewpoint of the base station as follows.

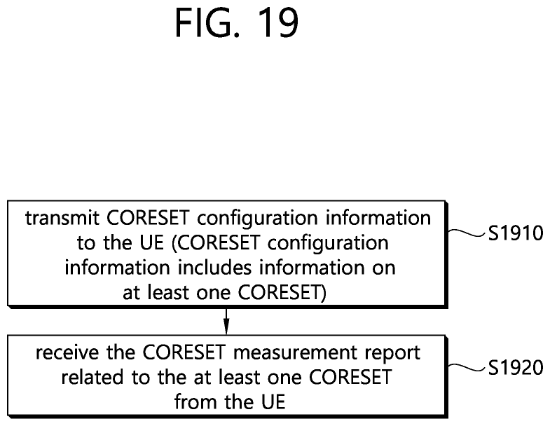

FIG. 19 is a flowchart of a method of receiving a report on a measurement result from the viewpoint of a base station, according to an embodiment of the present specification.

According to FIG. 19, the base station may transmit CORESET configuration information to the UE (S1910). The CORESET configuration information may include information on at least one CORESET.

After transmitting the CORESET configuration information, the base station may receive the CORESET measurement report related to the at least one CORESET from the UE (S1920).

From the viewpoint of the base station, a more specific example of a method for receiving a report on a measurement result is the same as described above, and thus repeated description will be omitted for convenience of description.

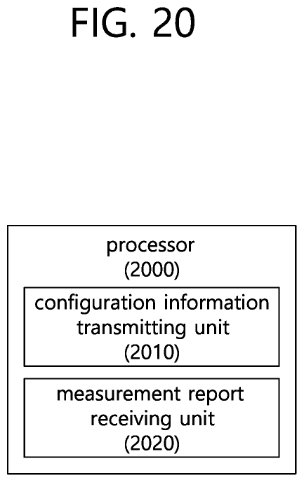

FIG. 20 is an example of a block diagram of an apparatus for receiving a report on a measurement result from the viewpoint of a base station, according to an embodiment of the present specification.

Referring to FIG. 20, the processor 2000 may include a configuration information transmitting unit 2010 and a measurement report receiving unit 2020. Here, the processor 2000 may be a processor in FIGS. 21 to 27 to be described later.

The configuration information transmission unit 2010 may be configured to transmit CORESET configuration information to the UE. The CORESET configuration information may include information on at least one CORESET.

The measurement report receiving unit 2020 may be configured to receive the CORESET measurement report related to the at least one CORESET from the UE after transmitting the CORESET configuration information.

From the viewpoint of the base station, a more specific example of a method for receiving a report on a measurement result is the same as described above, and thus repeated description will be omitted for convenience of description.

FIG. 21 shows an exemplary communication system (1), according to an embodiment of the present specification.

Referring to FIG. 21, a communication system (1) to which various embodiments of the present specification are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot (100a), vehicles (100b-1, 100b-2), an eXtended Reality (XR) device (100c), a hand-held device (100d), a home appliance (100e), an Internet of Things (IoT) device (100f), and an Artificial Intelligence (AI) device/server (400). For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, and so on. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device (200a) may operate as a BS/network node with respect to other wireless devices.

The wireless devices (100a˜100f) may be connected to the network (300) via the BSs (200). An Artificial Intelligence (AI) technology may be applied to the wireless devices (100a˜100f) and the wireless devices (100a˜100f) may be connected to the AI server (400) via the network (300). The network (300) may be configured using a 3G network, a 4G (e.g., LTE) network, or a 5G (e.g., NR) network. Although the wireless devices (100a˜100f) may communicate with each other through the BSs (200)/network (300), the wireless devices (100a˜100f) may perform direct communication (e.g., sidelink communication) with each other without passing through the BSs/network. For example, the vehicles (100b-1, 100b-2) may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices (100a˜100f).

Wireless communication/connections (150a, 150b, 150c) may be established between the wireless devices (100a˜100f)/BS (200), or BS (200)/BS (200). Herein, the wireless communication/connections may be established through various RATs (e.g., 5G NR) such as uplink/downlink communication (150a), sidelink communication (150b) (or D2D communication), or inter BS communication (150c) (e.g., relay, Integrated Access Backhaul (IAB)). The wireless devices and the BSs/the wireless devices may transmit/receive radio signals to/from each other through the wireless communication/connections (150a, 150b, 150c). For example, the wireless communication/connections (150a, 150b, 150c) may transmit/receive signals through various physical channels. For this, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present specification.

Meanwhile, in NR, multiple numerologies (or subcarrier spacing (SCS)) for supporting various 5G services may be supported. For example, in case an SCS is 15 kHz, a wide area of the conventional cellular bands may be supported, and, in case an SCS is 30 kHz/60 kHz dense-urban, lower latency, and wider carrier bandwidth may be supported. In case the SCS is 60 kHz or higher, a bandwidth that is greater than 24.25 GHz may be used in order to overcome phase noise.

An NR frequency band may be defined as two different types of frequency ranges (FR1, FR2). The values of the frequency ranges may be changed (or varied), and, for example, the two different types of frequency ranges (FR1, FR2) may be as shown below in Table 4. Among the frequency ranges that are used in an NR system, FR1 may mean a “sub 6 GHz range”, and FR2 may mean an “above 6 GHz range” and may also be referred to as a millimeter wave (mmW).

TABLE 4

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed (or varied). For example, as shown below in Table 5, 1-R1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 may include an unlicensed band. The unlicensed band may be used for various purposes, e.g., the unlicensed band for vehicle-specific communication (e.g., automated driving).

TABLE 5

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

Hereinafter, an example of wireless devices to which the present specification is applied will be described in detail.

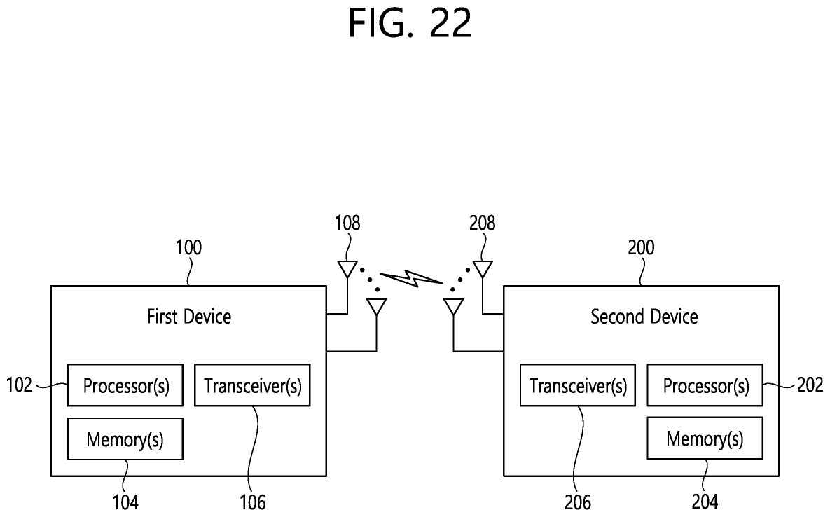

FIG. 22 shows an exemplary wireless device to which the present specification can be applied.

Referring to FIG. 22, a first wireless device (100) and a second wireless device (200) may transmit radio signals through a variety of RATs (e.g., LTE, NR). Herein, {the first wireless device (100) and the second wireless device (200)} may correspond to {the wireless device (100x) and the BS (200)} and/or {the wireless device (100x) and the wireless device (100x)} of FIG. 21.

The first wireless device (100) may include one or more processors (102) and one or more memories (104) and additionally further include one or more transceivers (106) and/or one or more antennas (108). The processor(s) (102) may control the memory(s) (104) and/or the transceiver(s) (106) and may be configured to implement the descriptions, functions, procedures, proposals, methods, and/or operational flowcharts disclosed in this document. For example, the processor(s) (102) may process information within the memory(s) (104) to generate first information/signals and then transmit radio signals including the first information/signals through the transceiver(s) (106). The processor(s) (102) may receive radio signals including second information/signals through the transceiver (106) and then store information obtained by processing the second information/signals in the memory(s) (104). The memory(s) (104) may be connected to the processor(s) (102) and may store various information related to operations of the processor(s) (102). For example, the memory(s) (104) may store software code including instructions for performing a part or the entirety of processes controlled by the processor(s) (102) or for performing the descriptions, functions, procedures, proposals, methods, and/or operational flowcharts disclosed in this document. Herein, the processor(s) (102) and the memory(s) (104) may be a part of a communication modem/circuit/chip designed to implement RAT (e.g., LTE or NR). The transceiver(s) (106) may be connected to the processor(s) (102) and transmit and/or receive radio signals through one or more antennas (108). Each of the transceiver(s) (106) may include a transmitter and/or a receiver. The transceiver(s) (106) may be interchangeably used with Radio Frequency (RF) unit(s). In the present specification, the wireless device may represent a communication modem/circuit/chip.

The second wireless device (200) may include one or more processors (202) and one or more memories (204) and additionally further include one or more transceivers (206) and/or one or more antennas (208). The processor(s) (202) may control the memory(s) (204) and/or the transceiver(s) (206) and may be configured to implement the descriptions, functions, procedures, proposals, methods, and/or operational flowcharts disclosed in this document. For example, the processor(s) (202) may process information within the memory(s) (204) to generate third information/signals and then transmit radio signals including the third information/signals through the transceiver(s) (206). The processor(s) (202) may receive radio signals including fourth information/signals through the transceiver(s) (206) and then store information obtained by processing the fourth information/signals in the memory(s) (204). The memory(s) (204) may be connected to the processor(s) (202) and may store various information related to operations of the processor(s) (202). For example, the memory(s) (204) may store software code including instructions for performing a part or the entirety of processes controlled by the processor(s) (202) or for performing the descriptions, functions, procedures, proposals, methods, and/or operational flowcharts disclosed in this document. Herein, the processor(s) (202) and the memory(s) (204) may be a part of a communication modem/circuit/chip designed to implement RAT (e.g., LTE or NR). The transceiver(s) (206) may be connected to the processor(s) (202) and transmit and/or receive radio signals through one or more antennas (208). Each of the transceiver(s) (206) may include a transmitter and/or a receiver. The transceiver(s) (206) may be interchangeably used with RF transceiver(s). In the present specification, the wireless device may represent a communication modem/circuit/chip.

Hereinafter, hardware elements of the wireless devices (100, 200) will be described in more detail. One or more protocol layers may be implemented by, without being limited to, one or more processors (102, 202). For example, the one or more processors (102, 202) may implement one or more layers (e.g., functional layers such as PHY, MAC, RLC, PDCP, RRC, and SDAP). The one or more processors (102, 202) may generate one or more Protocol Data Units (PDUs) and/or one or more Service Data Unit (SDUs) according to the descriptions, functions, procedures, proposals, methods, and/or operational flowcharts disclosed in this document. The one or more processors (102, 202) may generate messages, control information, data, or information according to the descriptions, functions, procedures, proposals, methods, and/or operational flowcharts disclosed in this document. The one or more processors (102, 202) may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers (106, 206). The one or more processors (102, 202) may receive the signals (e.g., baseband signals) from the one or more transceivers (106, 206) and obtain the PDUs, SDUs, messages, control information, data, or information according to the descriptions, functions, procedures, proposals, methods, and/or operational flowcharts disclosed in this document.

The one or more processors (102, 202) may be referred to as controllers, microcontrollers, microprocessors, or microcomputers. The one or more processors (102, 202) may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors (102, 202). The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors (102, 202) or stored in the one or more memories (104, 204) so as to be driven by the one or more processors (102, 202). The descriptions, functions, procedures, proposals, methods, and/or operational flowcharts disclosed in this document may be implemented using firmware or software in the form of code, instructions, and/or a set of instructions.

The one or more memories (104, 204) may be connected to the one or more processors (102, 202) and store various types of data, signals, messages, information, programs, code, instructions, and/or commands. The one or more memories (104, 204) may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories (104, 204) may be located at the interior and/or exterior of the one or more processors (102, 202). The one or more memories (104, 204) may be connected to the one or more processors (102, 202) through various technologies such as wired or wireless connection.

The one or more transceivers (106, 206) may transmit user data, control information, and/or radio signals/channels, mentioned in the methods and/or operational flowcharts of this document, to one or more other devices. The one or more transceivers (106, 206) may receive user data, control information, and/or radio signals/channels, mentioned in the descriptions, functions, procedures, proposals, methods, and/or operational flowcharts disclosed in this document, from one or more other devices. For example, the one or more transceivers (106, 206) may be connected to the one or more processors (102, 202) and transmit and receive radio signals. For example, the one or more processors (102, 202) may perform control so that the one or more transceivers (106, 206) may transmit user data, control information, or radio signals to one or more other devices. The one or more processors (102, 202) may perform control so that the one or more transceivers (106, 206) may receive user data, control information, or radio signals from one or more other devices. The one or more transceivers (106, 206) may be connected to the one or more antennas (108, 208) and the one or more transceivers (106, 206) may be configured to transmit and receive user data, control information, and/or radio signals/channels, mentioned in the descriptions, functions, procedures, proposals, methods, and/or operational flowcharts disclosed in this document, through the one or more antennas (108, 208). In this document, the one or more antennas may be a plurality of physical antennas or a plurality of logical antennas (e.g., antenna ports). The one or more transceivers (106, 206) may convert received radio signals/channels, and so on, from RF band signals into baseband signals in order to process received user data, control information, radio signals/channels, and so on, using the one or more processors (102, 202). The one or more transceivers (106, 206) may convert the user data, control information, radio signals/channels, and so on, processed using the one or more processors (102, 202) from the base band signals into the RF band signals. For this, the one or more transceivers (106, 206) may include (analog) oscillators and/or filters.

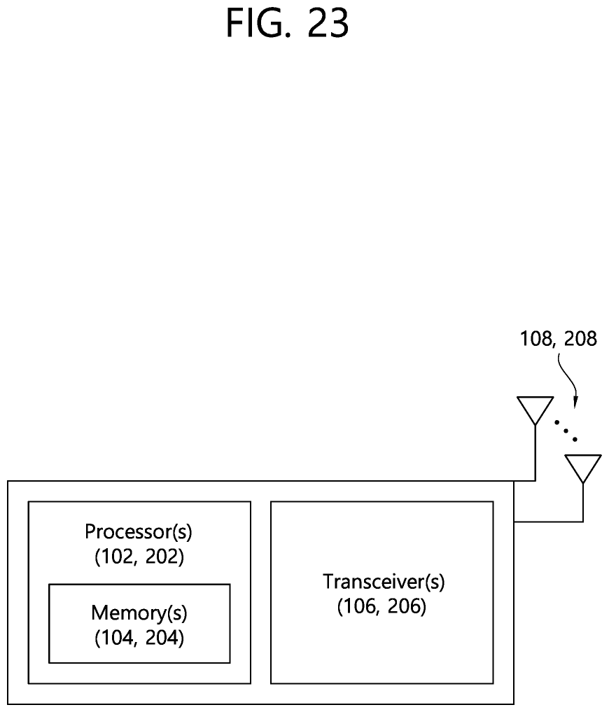

FIG. 23 shows another example of a wireless device applicable to the present specification.

According to FIG. 23, the wireless device may include at least one processor (102, 202), at least one memory (104, 204), at least one transceiver (106, 206), and/or one or more antennas (108, 208).

As a difference between the example of the wireless device described above in FIG. 22 and the example of the wireless device in FIG. 23, in FIG. 22, the processors 102 and 202 and the memories 104 and 204 are separated, but in the example of FIG. 23, the memories 104 and 204 are included in the processors 102 and 202.

Here, a detailed description of the processors 102 and 202, the memories 104 and 204, the transceivers 106 and 206, and the one or more antennas 108 and 208 is as described above, in order to avoid unnecessary repetition of description, description of repeated description will be omitted.

Hereinafter, an example of a signal processing circuit to which the present specification is applied will be described in detail.

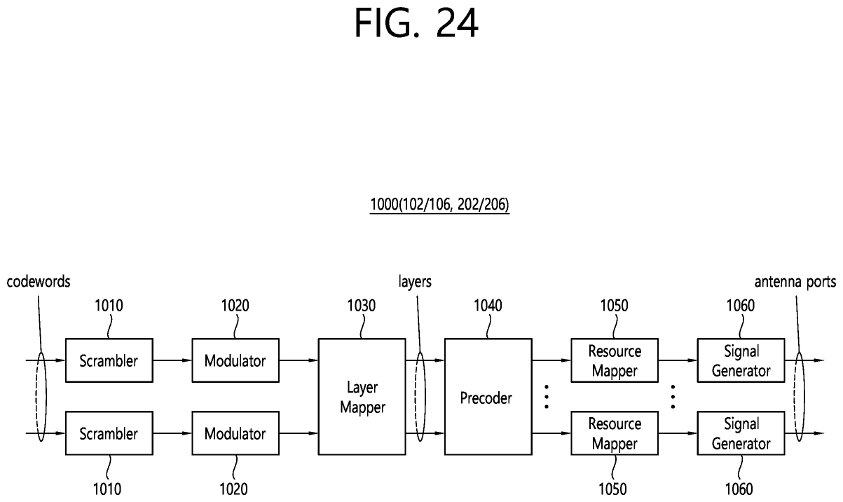

FIG. 24 shows a signal process circuit for a transmission signal according to an embodiment of the present specification.

Referring to FIG. 24, a signal processing circuit (1000) may include scramblers (1010), modulators (1020), a layer mapper (1030), a precoder (1040), resource mappers (1050), and signal generators (1060). An operation/function of FIG. 24 may be performed, without being limited to, the processors (102, 202) and/or the transceivers (106, 206) of FIG. 22. Hardware elements of FIG. 24 may be implemented by the processors (102, 202) and/or the transceivers (106, 206) of FIG. 22. For example, blocks 1010-1060 may be implemented by the processors (102, 202) of FIG. 22. Alternatively, the blocks 1010-1050 may be implemented by the processors (102, 202) of FIG. 22 and the block 1060 may be implemented by the transceivers (106, 206) of FIG. 22.

Codewords may be converted into radio signals via the signal processing circuit (1000) of FIG. 24. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

More specifically, the codewords may be converted into scrambled bit sequences by the scramblers (1010). Scramble sequences used for scrambling may be generated based on an initialization value, and the initialization value may include ID information of a wireless device. The scrambled bit sequences may be modulated to modulation symbol sequences by the modulators (1020). A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper (1030). Modulation symbols of each transport layer may be mapped (precoded) to corresponding antenna port(s) by the precoder (1040). Outputs z of the precoder (1040) may be obtained by multiplying outputs y of the layer mapper (1030) by an N*M precoding matrix W. Herein, N is the number of antenna ports, and M is the number of transport layers. The precoder (1040) may perform precoding after performing transform precoding (e.g., DFT) for complex modulation symbols. Additionally, the precoder (1040) may perform precoding without performing transform precoding.

The resource mappers (1050) may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators (1060) may generate radio signals from the mapped modulation symbols and the generated radio signals may be transmitted to other devices through each antenna. For this purpose, the signal generators (1060) may include Inverse Fast Fourier Transform (IFFT) modules, Cyclic Prefix (CP) inserters, Digital-to-Analog Converters (DACs), frequency uplink converters, and so on.

Signal processing procedures for a signal received in the wireless device may be configured in a reverse manner of the signal processing procedures (1010˜1060) of FIG. 24. For example, the wireless devices (e.g., 100, 200 of FIG. 22) may receive radio signals from the exterior through the antenna ports/transceivers. The received radio signals may be converted into baseband signals through signal restorers. For this, the signal restorers may include frequency downlink converters, Analog-to-Digital Converters (ADCs), CP remover, and Fast Fourier Transform (FFT) modules. Subsequently, the baseband signals may be restored to codewords through a resource demapping procedure, a postcoding procedure, a demodulation processor, and a descrambling procedure. The codewords may be restored to original information blocks through decoding. Therefore, a signal processing circuit (not shown) for a reception signal may include signal restorers, resource demappers, a postcoder, demodulators, descramblers, and decoders.

Hereinafter, a usage example of the wireless to which the present specification is applied will be described in detail.

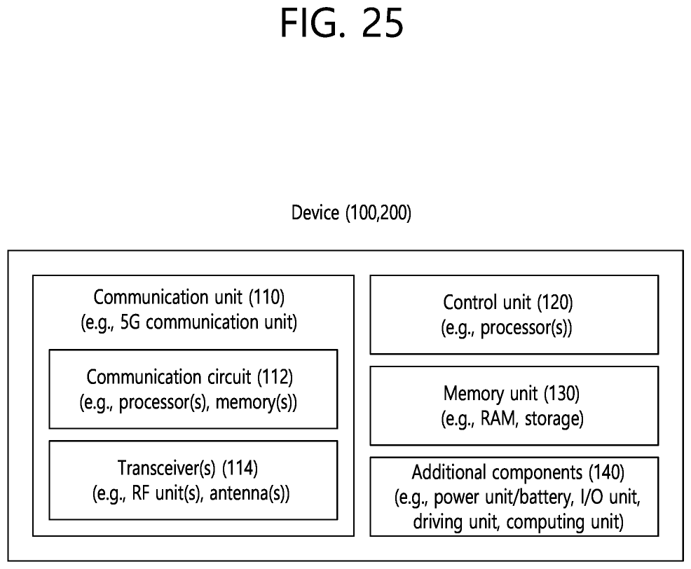

FIG. 25 shows another example of a wireless device according to an embodiment of the present specification. The wireless device may be implemented in various forms according to a use-case/service (refer to FIG. 21).

Referring to FIG. 25, wireless devices (100, 200) may correspond to the wireless devices (100, 200) of FIG. 22 and may be configured by various elements, components, units/portions, and/or modules. For example, each of the wireless devices (100, 200) may include a communication unit (110), a control unit (120), a memory unit (130), and additional components (140). The communication unit may include a communication circuit (112) and transceiver(s) (114). For example, the communication circuit (112) may include the one or more processors (102, 202) and/or the one or more memories (104, 204) of FIG. 22. For example, the transceiver(s) (114) may include the one or more transceivers (106, 206) and/or the one or more antennas (108, 208) of FIG. 22. The control unit (120) is electrically connected to the communication unit (110), the memory (130), and the additional components (140) and controls overall operation of the wireless devices. For example, the control unit (120) may control an electric/mechanical operation of the wireless device based on programs/code/instructions/information stored in the memory unit (130). The control unit (120) may transmit the information stored in the memory unit (130) to the exterior (e.g., other communication devices) via the communication unit (110) through a wireless/wired interface or store, in the memory unit (130), information received through the wireless/wired interface from the exterior (e.g., other communication devices) via the communication unit (110).

The additional components (140) may be variously configured according to types of wireless devices. For example, the additional components (140) may include at least one of a power unit/battery, input/output (I/O) unit, a driving unit, and a computing unit. The wireless device may be implemented in the form of, without being limited to, the robot (100a of FIG. 21), the vehicles (100b-1, 100b-2 of FIG. 21), the XR device (100c of FIG. 21), the hand-held device (100d of FIG. 21), the home appliance (100e of FIG. 21), the IoT device (100f of FIG. 21), a digital broadcast terminal, a hologram device, a public safety device, an MTC device, a medicine device, a fintech device (or a finance device), a security device, a climate/environment device, the AI server/device (400 of FIG. 21), the BSs (200 of FIG. 21), a network node, and so on. The wireless device may be used in a mobile or fixed place according to a usage-example/service.

In FIG. 25, the entirety of the various elements, components, units/portions, and/or modules in the wireless devices (100, 200) may be connected to each other through a wired interface or at least a part thereof may be wirelessly connected through the communication unit (110). For example, in each of the wireless devices (100, 200), the control unit (120) and the communication unit (110) may be connected by wire and the control unit (120) and first units (e.g., 130, 140) may be wirelessly connected through the communication unit (110). Each element, component, unit/portion, and/or module within the wireless devices (100, 200) may further include one or more elements. For example, the control unit (120) may be configured by a set of one or more processors. As an example, the control unit (120) may be configured by a set of a communication control processor, an application processor, an Electronic Control Unit (ECU), a graphical processing unit, and a memory control processor. As another example, the memory (130) may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 25 will be described in detail with reference to the drawings.

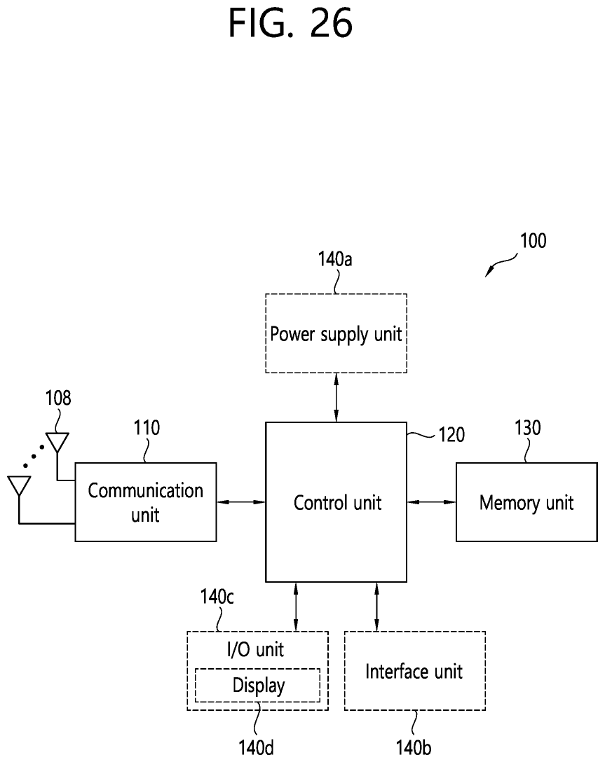

FIG. 26 shows a hand-held device to which the present specification is applied. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 26, a hand-held device (100) may include an antenna unit (108), a communication unit (110), a control unit (120), a memory unit (130), a power supply unit (140a), an interface unit (140b), and an I/O unit (140c). The antenna unit (108) may be configured as a part of the communication unit (110). Blocks 110˜130/140a˜140c correspond to the blocks 110˜130/140 of FIG. 25, respectively.

The communication unit (110) may transmit and receive signals (e.g., data and control signals) to and from other wireless devices or BSs. The control unit (120) may perform various operations by controlling constituent elements of the hand-held device (100). The control unit (120) may include an Application Processor (AP). The memory unit (130) may store data/parameters/programs/code/instructions (or commands) needed to drive the hand-held device (100). The memory unit (130) may store input/output data/information. The power supply unit (140a) may supply power to the hand-held device (100) and include a wired/wireless charging circuit, a battery, and so on. The interface un,it (140b) may support connection of the hand-held device (100) to other external devices. The interface unit (140b) may include various ports (e.g., an audio I/O port and a video I/O port) for connection with external devices. The I/O unit (140c) may input or output video information/signals, audio information/signals, data, and/or information input by a user. The I/O unit (140c) may include a camera, a microphone, a user input unit, a display unit (140d), a speaker, and/or a haptic module.

As an example, in the case of data communication, the I/O unit (140c) may obtain information/signals (e.g., touch, text, voice, images, or video) input by a user and the obtained information/signals may be stored in the memory unit (130). The communication unit (110) may convert the information/signals stored in the memory into radio signals and transmit the converted radio signals to other wireless devices directly or to a BS. The communication unit (110) may receive radio signals from other wireless devices or the BS and then restore the received radio signals into original information/signals. The restored information/signals may be stored in the memory unit (130) and may be output as various types (e.g., text, voice, images, video, or haptic) through the I/O unit (140c).

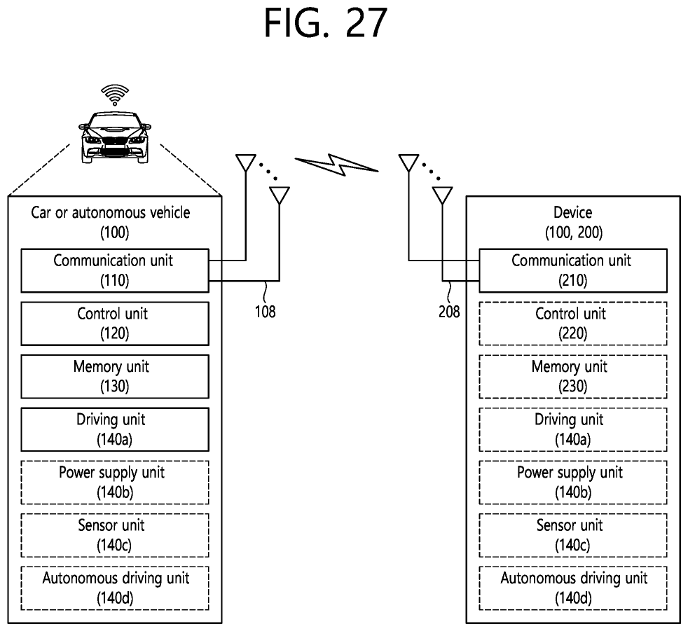

FIG. 27 shows a vehicle or an autonomous vehicle to which the present specification is applied. The vehicle or autonomous vehicle may be implemented by a mobile robot, a car, a train, a manned/unmanned Aerial Vehicle (AV), a ship, and so on.

Referring to FIG. 27, a vehicle or autonomous vehicle (100) may include an antenna unit (108), a communication unit (110), a control unit (120), a driving unit (140a), a power supply unit (140b), a sensor unit (140c), and an autonomous driving unit (140d). The antenna unit (108) may be configured as a part of the communication unit (110). The blocks 110/130/140a˜140d correspond to the blocks 110/130/140 of FIG. 25, respectively.

The communication unit (110) may transmit and receive signals (e.g., data and control signals) to and from external devices such as other vehicles, BSs (e.g., gNBs and road side units), and servers. The control unit (120) may perform various operations by controlling elements of the vehicle or the autonomous vehicle (100). The control unit (120) may include an Electronic Control Unit (ECU). The driving unit (140a) may cause the vehicle or the autonomous vehicle (100) to drive on a road. The driving unit (140a) may include an engine, a motor, a powertrain, a wheel, a brake, a steering device, and so on. The power supply unit (140b) may supply power to the vehicle or the autonomous vehicle (100) and include a wired/wireless charging circuit, a battery, and so on. The sensor unit (140c) may obtain a vehicle state, ambient environment information, user information, and so on. The sensor unit (140c) may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit (140d) may implement technology for maintaining a lane on which a vehicle is driving, technology for automatically adjusting speed, such as adaptive cruise control, technology for autonomously driving along a determined path, technology for driving by automatically setting a path if a destination is set, and so on.

For example, the communication unit (110) may receive map data, traffic information data, and so on, from an external server. The autonomous driving unit (140d) may generate an autonomous driving path and a driving plan from the obtained data. The control unit (120) may control the driving unit (140a) such that the vehicle or the autonomous vehicle (100) may move along the autonomous driving path according to the driving plan (e.g., speed/direction control). In the middle of autonomous driving, the communication unit (110) may aperiodically/periodically obtain recent traffic information data from the external server and obtain surrounding traffic information data from neighboring vehicles. In the middle of autonomous driving, the sensor unit (140c) may obtain a vehicle state and/or surrounding environment information. The autonomous driving unit (140d) may update the autonomous driving path and the driving plan based on the newly obtained data/information. The communication unit (110) may transfer information on a vehicle position, the autonomous driving path, and/or the driving plan to the external server. The external server may predict traffic information data using AI technology, and so on, based on the information collected from vehicles or autonomous vehicles and provide the predicted traffic information data to the vehicles or the autonomous vehicles.

Claims in the present specification may be combined in various ways. For instance, technical features in method claims of the present specification may be combined to be implemented or performed in an apparatus (or device), and technical features in apparatus claims may be combined to be implemented or performed in a method. Further, technical features in method claim(s) and apparatus claim(s) may be combined to be implemented or performed in an apparatus. Further, technical features in method claim(s) and apparatus claim(s) may be combined to be implemented or performed in a method.

1. A method for transmitting a control resource set (CORESET) measurement report in a wireless communication system, the method performed by a user equipment (UE) and comprising:
receiving, from a base station, CORESET configuration information,
wherein the CORESET configuration information includes information for at least one CORESET;
performing a measurement for each of the at least one CORESET; and
transmitting, to the base station, the CORESET measurement report based on a result of the measurement.

2. The method of claim 1, wherein the UE performs the measurement for a transmission configuration indication (TCI) associated with each of the at least one CORESET.

3. The method of claim 1, wherein the CORESET measurement report includes low quality COREST information,
wherein the low quality CORESET information is information for a specific CORESET having a result of a measurement lower than a first threshold value among the at least one CORESET.

4. The method of claim 3, wherein the UE skips monitoring for the specific CORESET.

5. The method of claim 4, wherein the UE skips the monitoring:
from a first monitoring occasion of the specific CORESET after a time of transmitting the CORESET measurement report; or
after a certain time has elapsed since the time of transmitting the CORESET measurement report.

6. The method of claim 4, wherein the UE receives a response for the CORESET measurement report from the base station,
wherein the UE skips the monitoring:
from a time of receiving the response; or
after a certain time has elapsed since the time of receiving the response.

7. The method of claim 3, wherein, based on the result of the measurement of the specific CORESET being greater than or equal to a second threshold,
wherein the UE transmits a report for restarting the monitoring on the specific CORESET to the base station.

8. The method of claim 7, wherein the UE restarts the monitoring for the specific CORESET after a certain time has elapsed since transmitting the CORESET measurement report.

9. The method of claim 1, wherein the UE transmits a report of physical downlink control channel (PDCCH) channel state information (CSI) for the at least one CORESET.

10. The method of claim 9, wherein, based on the UE transmitting a report for a preferred aggregation level (AL) to the base station,
wherein a reference downlink control information (DCI) size to which the preferred AL is applied is a DCI size monitored by a specific search space (SS) set among at least one SS set associated with the at least one CORESET.

11. A user equipment (UE) comprising:
a transceiver;
at least one memory; and
at least one processor being operatively connected to the at least one memory and the transceiver,
wherein the at least one processor is configured to:
control the transceiver to receive, from a base station, control resource set (CORESET) configuration information,
wherein the CORESET configuration information includes information for at least one CORESET;
perform a measurement for each of the at least one CORESET; and
control the transceiver to transmit, to the base station, a CORESET measurement report based on a result of the measurement.

12. The UE of claim 11, wherein the at least one processor is configured to perform the measurement for a transmission configuration indication (TCI) associated with each of the at least one CORESET.

13. The UE of claim 11, wherein the CORESET measurement report includes low quality COREST information,
wherein the low quality CORESET information is information for a specific CORESET having a result of a measurement lower than a first threshold value among the at least one CORESET.

14. The UE of claim 13, wherein the at least one processor is configured to skip monitoring for the specific CORESET.

15. The UE of claim 14, wherein the at least one processor is configured to skip the monitoring:
from a first monitoring occasion of the specific CORESET after a time of transmitting the CORESET measurement report; or
after a certain time has elapsed since the time of transmitting the CORESET measurement report.

16. The UE of claim 14, wherein the at least one processor is configured to control the transceiver to receive a response for the CORESET measurement report from the base station,
wherein the at least one processor is configured to skip the monitoring:
from a time of receiving the response; or
after a certain time has elapsed since the time of receiving the response.

17. The UE of claim 13, wherein, based on the result of the measurement of the specific CORESET being greater than or equal to a second threshold,
wherein the at least one processor is configured to control the transceiver to transmit a report for restarting the monitoring on the specific CORESET to the base station.

18. The UE of claim 17, wherein the at least one processor is configured to restart the monitoring for the specific CORESET after a certain time has elapsed since transmitting the CORESET measurement report.

19. The UE of claim 11, wherein the at least one processor is configured to control the transceiver to transmit a report of physical downlink control channel (PDCCH) channel state information (CSI) for the at least one CORESET.

20. The UE of claim 19, wherein, based on the at least one processor configured to transmit a report for a preferred aggregation level (AL) to the base station,
wherein a reference downlink control information (DCI) size to which the preferred AL is applied is a DCI size monitored by a specific search space (SS) set among at least one SS set associated with the at least one CORESET.

21-50. (cancel)
